(19) United States
(12) Patent Application Publication
(10) Pub. No.: US 2026/0360734 A1
(43) Pub. Date: Nov. 12, 2026

(54) BATTERY CELL, BATTERY APPARATUS, ELECTRICAL APPARATUS, AND ENERGY STORAGE APPARATUS

(71) Applicant: CONTEMPORARY AMPEREX TECHNOLOGY CO., LIMITED, Ningde (CN)

(72) Inventors: Xinde Ye, Ningde (CN); Xiaofeng Zhang, Ningde (CN); Xiaoyang Jia, Ningde (CN); Chengjun Han, Ningde (CN); Jia Li, Ningde (CN); Tianyue Yuan, Ningde (CN); Song Li, Ningde (CN)

(21) Appl. No.: 19/449,461

(22) Filed: Jan. 15, 2026

Related U.S. Application Data
(63) Continuation of application No. PCT/CN2025/094408, filed on May 12, 2025.

(51) Int. Cl. H01M 4/58; H01M 4/02; H01M 4/62; H01M 50/122; H01M 50/426; H01M 50/434; H01M 50/449; H01M 50/489

(52) U.S. Cl. CPC H01M 4/5825; H01M 4/623; H01M 4/625; H01M 50/122; H01M 50/426; H01M 50/434; H01M 50/449; H01M 50/489; H01M 2004/021; H01M 2004/028

(57) ABSTRACT

The present application provides a battery cell, a battery apparatus, an electrical apparatus, and an energy storage apparatus. The battery cell includes a stacked-type cell having a positive electrode plate and a negative electrode plate. The positive electrode plate includes a current collector and a positive electrode film layer formed on at least one side of the current collector. The film layer includes lithium-containing transition metal phosphate particles with carbon material on part of their surfaces. When fully discharged, the positive electrode plate has a compacted density of 2.3-2.6 g/cm³, and the film layer has a single-side surface density of 0.25-0.45 g per 1540.25 mm². In a cross-section along the thickness direction, 12%-50% of the particles have a size R1≥1000 nm, with a distribution uniformity of such particles≤5%. The battery cell offers high capacity and good cycle performance.

### CROSS-REFERENCE TO RELATED APPLICATIONS

The present application is a continuation of International Application PCT/CN2025/094408, filed on May 12, 2025, the entire contents of which are incorporated herein by reference.

### TECHNICAL FIELD

The present application relates to the technical field of batteries, in particular to a battery cell, a battery apparatus, an electrical apparatus, and an energy storage apparatus.

### BACKGROUND

In recent years, battery cells have been widely used in energy storage power systems such as hydropower, thermal power, wind power and solar power stations, as well as the fields of power tools, electric bicycles, electric motorcycles, electric vehicles, military equipment, aerospace and other fields.

As the market pursues longer battery life and longer service life, higher requirements are placed on battery capacity and cycle performance. However, it is difficult to achieve simultaneous improvement of the above-mentioned performance with existing technologies, and how to balance the two has become a technical problem that urgently needs to be solved in the art.

### SUMMARY OF THE INVENTION

The present application is conducted in view of the above issues, and aims to provide a battery cell which has both high capacity and good cycle performance.

A first aspect of the present application provides a battery cell. The battery cell includes a stacked electrode assembly, the stacked electrode assembly includes a positive electrode plate and a negative electrode plate, the positive electrode plate includes a positive electrode current collector and a positive electrode film layer disposed on at least one side of the positive electrode current collector, and the positive electrode film layer includes lithium-containing transition metal phosphate particles with a carbon material disposed on at least a portion of surfaces. When the battery cell is fully discharged, the positive electrode plate has a compacted density of 2.3 g/cm³ to 2.6 g/cm³; a single-side surface density of the positive electrode film layer is 0.25 g/1540.25 mm² to 0.45 g/1540.25 mm²; based on a total area of particles in a cross-section of the positive electrode film layer along a thickness direction of the electrode plate, an area proportion of particles having a particle size R1 satisfying R1≥1000 nm is 12% to 50%; and in the cross-section of the positive electrode film layer along the thickness direction of the electrode plate, a distribution uniformity of the particles having the particle size R1 satisfying R1≥1000 nm is less than or equal to 5%.

Compared with ternary materials, lithium-containing transition metal phosphates have a more stable structure and are less likely to break under high pressure. During the electrode plate compaction process, the lithium-containing transition metal phosphates need to withstand higher pressures in order to increase the compacted density. However, studies have shown that when a battery cell is fully discharged, if the compacted density of the positive electrode plate is greater than 2.6 g/cm³, the sheet will have over-voltage, resulting in large stress concentration, which can easily cause the positive electrode film layer to fall off during the cycle; when a battery cell is fully discharged, if the compacted density of the positive electrode plate is less than 2.3 g/cm³, the positive electrode film layer particles will not be tightly connected, increasing the internal resistance of a battery and reducing the energy density of the battery cell. The single-side surface density of the positive electrode film layer is less than 0.25 g/1540.25 mm², and the content of positive electrode active materials loaded in the battery cell is low, which cannot effectively improve the energy density of the battery. The single-side surface density of the positive electrode film layer is greater than 0.45 g/1540.25 mm², which will make the positive electrode film layer too thick. The stress distribution of the positive electrode film layer is uneven during the compaction process, and local stress concentration is likely to cause the film layer to fall off. Controlling the compacted density of the positive electrode plate to 2.3 g/cm³ to 2.6 g/cm³ and the single-side surface density of the positive electrode film layer to 0.25 g/1540.25 mm² to 0.45 g/1540.25 mm² can improve the energy density while maintaining a low risk of falling off of the positive electrode film layer.

The applicant further discovered that the expansion volume of thick-coated electrode plates increases significantly during battery charging and discharging, making it easy for the thick-coated electrode plates to experience film layer falling-off in the later stages of long cycles, where large particles in the film layer are likely to be the starting point for film layer falling-off. Studies have shown that large particles are prone to cause stress concentration and cracks during the film layer compaction process. However, if the content of large particles in the positive electrode film layer is too low, it will limit the increase in the compacted density of the positive electrode film layer. Studies have shown that the compacted density of the positive electrode plate is controlled at 2.3 g/cm³ to 2.6 g/cm³, and the single-side surface density of the positive electrode film layer is 0.25 g/1540.25 mm² to 0.45 g/1540.25 mm². Based on the total area of the particles in the cross-section of the positive electrode film layer along the thickness direction of the electrode plate, the area proportion of particles having a particle size R1 satisfying R1≥1000 nm is less than 12%, which will reduce the energy density of the battery. Based on the total area of the particles in the cross-section of the positive electrode film layer along the thickness direction of the electrode plate, the area proportion of particles having a particle size R1 satisfying R1≥1000 nm is more than 50%, which will easily cause stress concentration during the film layer compaction process and uneven expansion during the cycle, thereby causing the film layer to shed powder or even fall off. In the cross-section of the positive electrode film layer along the thickness direction of the electrode plate, the distribution uniformity of particles having the particle size R1 satisfying R1≥1000 nm is greater than 5%, which will increase the stress concentration during the compaction process of the film layer, further increase the uneven expansion during the cycle, and increase the risk of film layer powder loss and falling-off.

The battery cell includes a stacked electrode assembly. When the battery cell is fully discharged, the compacted density of the positive electrode plate is 2.3 g/cm³ to 2.6 g/cm³, the single-side surface density of the positive electrode film layer is 0.25 g/1540.25 mm² to 0.45 g/1540.25 mm², and based on the total area of particles in a cross-section of the positive electrode film layer along the thickness direction of the electrode plate, the area proportion of particles having a particle size R1 satisfying R1≥1000 nm is 12% to 50%, and in a cross-section of the positive electrode film layer along the thickness direction of the electrode plate, the distribution uniformity of particles having a particle size R1 satisfying R1≥1000 nm is less than or equal to 5%. First of all, compared with wound cells, stacked electrode assemblies have no corner areas, which can effectively improve the space utilization of the battery, thereby increasing the volumetric energy density; and the lack of corner areas helps to reduce stress concentration, reduce the probability of film layer falling-off, and reduce the risk of battery capacity plummeting. Secondly, by controlling the compacted density and the single-side coating surface density within the above range, it is not only beneficial to increase the loading amount of the positive electrode active material, but also to control the porosity of the positive electrode film layer within an appropriate range, thereby increasing the infiltration rate of an electrolyte solution, so that the gram capacity of the active material can be fully utilized, and further improving the volumetric energy density of the battery. In addition, the examples of the present application further help to increase the loading amount of the positive electrode active material and improve the stress distribution by controlling the content of large particles in the positive electrode film layer and their distribution uniformity, thereby alleviating the negative impact of stress concentration, thereby facilitating taking into account the capacity and cycle stability of the battery and reducing the risk of battery capacity plummeting.

In summary, the battery cells provided in the examples of the present application have good capacity and good capacity cycle stability.

In any embodiment, the single-side coating surface density of the positive electrode film layer is 0.3 g/1540.25 mm² to 0.45 g/1540.25 mm².

In any embodiment, the single-side coating surface density of the positive electrode film layer is 0.35 g/1540.25 mm² to 0.4 g/1540.25 mm².

The single-side coating surface density of the positive electrode film layer is further within the above range, which helps to further improve the capacity of the battery while taking into account the cycle performance.

In any embodiment, based on the total area of particles in a cross-section of the positive electrode film layer along the thickness direction of the electrode plate, the area proportion of the particles having the particle size R1 satisfying R1≥1000 nm is 12% to 37%.

Large particles having a particle size R1 satisfying R1≥1000 nm help to increase the compacted density of the positive electrode plate, thereby increasing the volumetric energy density of the battery cell; however, researchers have found that these large particles are prone to cause stress concentration, increasing the risk of positive electrode film layer falling-off. Therefore, the area proportion of the particles having the particle size R1 satisfying R1≥1000 nm in the cross-section of the positive electrode film layer along the thickness direction of the electrode plate is further within the range of 12% to 37%, which can not only improve the compacted density of the electrode plate, but also prevent the probability of film layer falling off from being too high. In this way, while improving the energy density of thick-coated lithium-containing transition metal phosphate batteries, it can alleviate the capacity plummeting problem and take into account the cycle life of the battery.

In any embodiment, the distribution uniformity of the particles having the particle size R1 satisfying R1≥1000 nm in a cross-section of the positive electrode film layer along the thickness direction of the electrode plate is 0.2% to 2%.

In any embodiment, the distribution uniformity of the particles having the particle size R1 satisfying R1≥1000 nm in a cross-section of the positive electrode film layer along the thickness direction of the electrode plate is 0.2% to 0.9%.

The distribution uniformity of the particles having the particle size R1 satisfying R1≥1000 nm in the cross-section of the positive electrode film layer along the thickness direction of the electrode plate is 0.2% to 2%, and further within the range of 0.2% to 0.9%. This can effectively reduce the stress concentration in local areas of the film layer, so that the stress in the film layer compaction process can be evenly dispersed in the entire area of the film layer, thereby further improving the battery energy density while reducing the probability of film layer falling-off, alleviating the capacity plummeting problem of thick-coated lithium-containing transition metal phosphate batteries, and improving the battery cycle life.

In any embodiment, a single-side thickness H of the positive electrode film layer is 70 μm to 120 μm.

In any embodiment, the single-side thickness H of the positive electrode film layer is 90 μm to 120 μm.

The single-side thickness of the positive electrode film layer being within the above range helps to increase the loading amount of the positive electrode active material in the battery, thereby increasing the capacity of the battery.

In any embodiment, a single-side thickness H of the positive electrode film layer is 100 μm to 120 μm.

Increasing the thickness of the positive electrode film layer helps to increase the loading amount of the positive electrode active material and helps to increase the capacity of the battery. However, the applicant found that when the single-side thickness of the positive electrode film layer is greater than or equal to 100 μm, during the battery cycle, the volume expansion of the positive electrode film layer is more significant, thereby generating greater stress, and the stress concentration in the positive electrode film layer is more significant. The risk of film layer falling-off increases, thereby affecting the cycle performance of the battery. In the examples of the present application, the capacity of the battery is increased by increasing the thickness of the positive electrode film layer, at the same time, based on the total area of the particles in the cross-section of the positive electrode film layer along the thickness direction of the electrode plate, the area proportion of the particles having the particle size R1 satisfying R1≥1000 nm is controlled, in the cross-section of the positive electrode film layer along the thickness direction of the electrode plate, the distribution uniformity of the particles having the particle size R1 satisfying R1≥1000 nm is controlled, the content of the large particles in the positive electrode film layer is controlled to be within the reasonable range and their distribution uniformity is improved, so that the stress concentration at the large particles is alleviated, thereby improving the battery capacity while taking into account the cycle performance of the battery.

In any embodiment, in the cross-section of the positive electrode film layer along the thickness direction of the electrode plate, in a cumulative distribution curve of sphericity area of the particles having the particle size R1 satisfying R1≥1000 nm, the median sphericity L_{R1A50} is 0.6 to 0.8.

In the examples of the present application, in the cross-section of the positive electrode film layer along the thickness direction of the electrode plate, L_{R1A}50 of the particles having the particle size R1 satisfying R1≥1000 nm is within the above range. The particles having the particle size R1 satisfying R1≥1000 nm have high roundness, which helps to improve the slippage of the particles in the positive electrode film layer, reduce stress concentration during the compaction of thick-coated film layers, and reduce the probability of film layer falling-off due to local stress concentration during long cycles of the positive electrode film layer. This further improves the volumetric energy density of the lithium-containing transition metal phosphate battery while improving the capacity plummeting problem of the battery cell and extending the cycle life.

In any embodiment, in the cross-section of the positive electrode film layer along the thickness direction of the electrode plate, in the cumulative distribution curve of sphericity area of the particles having the particle size R1 satisfying R1≥1000 nm, the median sphericity L_{R1A50} is 0.65 to 0.75.

In any embodiment, in the cross-section of the positive electrode film layer along the thickness direction of the electrode plate, in a cumulative distribution curve of sphericity area of the particles having the particle size R1 satisfying R1≥1000 nm, the median sphericity L_{R1A50} is 0.67 to 0.75.

In the cross-section of the positive electrode film layer along the thickness direction of the electrode plate, in the cumulative distribution curve of sphericity area of the particles having the particle size R1 satisfying R1≥1000 nm, the median sphericity L_{R1A50} is further within a range of 0.65 to 0.75, and furthermore within the range of 0.67 to 0.75, which helps to further extend the cycle life of thick-coated lithium-containing transition metal phosphate batteries.

In any embodiment, in a cumulative distribution curve of degree of graphitization C value of the positive electrode film layer obtained by a laser microscopic confocal Raman spectrometer in a surface scanning mode, a median C₅₀ of the degree of graphitization is greater than or equal to 0.95 and less than or equal to 1.2; wherein the degree of graphitization C value is I_{G}/I_{D}, I_{G} represents the G-band intensity of the Raman spectrum at 1580±100 cm⁻¹, and I_{D} represents the D-band intensity of the Raman spectrum at 1350±100 cm⁻¹.

The higher the degree of graphitization of the carbon on the surface of the positive electrode active material, the higher the proportion of graphite structure carbon in the positive electrode film layer, and the easier it is for the particles to slip with the help of the highly graphitized carbon structure in the coating layer, reducing the stress concentration in the electrode plate.

In the examples of the present application, the median C₅₀ of the degree of graphitization is within the above range, which helps to improve the slippage of the particles in the positive electrode film layer, reduce stress concentration during the compaction of the thick-coated film layer, and reduce the probability of film layer falling-off due to local stress concentration during long cycles of the positive electrode film layer, thereby further alleviating the capacity plummeting problem of the battery cell while improving the volumetric energy density of the battery, and extend the cycle life of the battery.

In any embodiment, in a cumulative distribution curve of coating value B of the positive electrode film layer obtained by a laser microscopic confocal Raman spectrometer in a surface scanning mode, a median B₅₀ of the coating value is 0.30 to 0.60, wherein the coating value B is I_{P}/I_{D}, I_{P} represents the P-band intensity of the Raman spectrum at 948±100 cm⁻¹, and I_{D} represents the D-band intensity of the Raman spectrum at 1350±100 cm⁻¹.

The median B₅₀ of the coating value of the positive electrode film layer being within the above range indicates that the carbon material layer of the positive electrode active material is relatively dense and uniform, which is beneficial to improving the slip uniformity of the positive electrode film layer during rolling and reducing the stress concentration in the thick-coated positive electrode film layer. In addition, with the help of the dense and uniform carbon material layer, the large particles in the positive electrode film layer are easier to slip during the compaction process, thereby reducing the stress concentration at the large particles in the thick-coated positive electrode film layer, reducing the probability of the positive electrode film layer falling off, alleviating the battery capacity plummeting problem, and extending the cycle life of the battery.

In any embodiment, the lithium-containing transition metal phosphate particles in the positive electrode film layer include components represented by the following general formula:

LiₘFeₓP_{y}OⱼQ_{q} Formula I,
where Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

In any embodiment, the lithium-containing transition metal phosphate particles in the positive electrode film layer include one or more of lithium iron phosphate, lithium manganese phosphate, lithium vanadium fluorophosphate, lithium manganese iron phosphate and their modified materials.

In any embodiment, the lithium-containing transition metal phosphate particles in the positive electrode film layer include one or more of lithium iron phosphate and its doping modification materials and coating modification materials.

In any embodiment, an iron dissolution rate of a positive electrode material is 658 ppm to 1921 ppm.

In any embodiment, the iron dissolution rate of the positive electrode material is 658 ppm to 1485 ppm.

The iron element dissolved in the positive electrode material mainly comes from the lithium-containing transition metal phosphate in the positive electrode active material. The iron dissolution rate depends on the number of lattice defects of the lithium-containing transition metal phosphate on the one hand, and on the integrity and density of the carbon material layer on the surface of the positive electrode active material on the other hand. The lower the iron dissolution rate means that the lithium-containing transition metal phosphate has fewer lattice defects, which is beneficial to reducing the corrosion of the lattice in a weak acid environment; and the more complete and dense the carbon material layer on the surface of the positive electrode active material, the more they inhibit the dissolution of iron ions in a weak acid environment. The positive electrode material with the iron dissolution rate within the above range has relatively few lattice defects and a complete and dense carbon material layer, which is beneficial to improving the compressive resistance and slippage of the particles in the positive electrode film layer under large rolling pressure, increasing the compacted density of the thick-coated positive electrode film layer and reducing stress concentration in the positive electrode film layer, improving the energy density of the battery while taking into account the alleviation of the battery capacity plummeting problem and extending the cycle life of the battery.

In any embodiment, based on the total mass of the lithium-containing transition metal phosphate particles in the positive electrode film layer, the mass content of a titanium element is 500 ppm to 8000 ppm.

In any embodiment, based on the total mass of the lithium-containing transition metal phosphate particles in the positive electrode film layer, the mass content of a titanium element is 1000 ppm to 3000 ppm.

The introduction of the titanium element into the lithium-containing transition metal phosphate particles requires the addition of a titanium source during the preparation of the positive electrode active material. The titanium source is often inert materials, and adhering to the surface of lithium-containing transition metal phosphate raw materials can reduce reaction activity and reduce particle size growth. Increasing the degree of graphitization of the positive electrode active material often requires a higher sintering temperature or a longer sintering time, but this will also increase the size of the particles in the positive electrode film layer, increase the stress concentration of the positive electrode film layer, and cause the positive electrode film layer to fall off. In the examples of the present application, a high content of titanium elements is added to the lithium-containing transition metal phosphate particles, so that the reactivity of the raw materials for synthesizing the positive electrode active material is reduced, the positive electrode active material can achieve control of the proportion of large particles while having a high degree of graphitization, stress concentration in the positive electrode film layer is reduced, and the probability of film layer falling-off of the positive electrode film layer is reduced, thereby improving the battery energy density while taking into account the cycle life of the battery.

At the same time, the doping of the titanium element in the positive electrode active material is beneficial to cause lattice distortion, reduce Li—O bond energy, increase a lithium ion transmission rate, and improve the kinetic performance of the battery. The lithium ion diffusion in the thick-coated film layer is uneven, often accompanied by a significant lithium ion concentration gradient. The example of the present application improves the solid-phase transmission rate of the positive electrode active material by adding a high content of titanium elements to the lithium-containing transition metal phosphate particles, thereby improving the kinetic problems of thick electrode plate batteries.

In any embodiment, based on the total mass of the lithium-containing transition metal phosphate particles in the positive electrode film layer, the mass content of a vanadium element is 500 ppm to 5000 ppm.

In any embodiment, based on the total mass of the lithium-containing transition metal phosphate particles in the positive electrode film layer, the mass content of a vanadium element is 500 ppm to 3000 ppm.

The vanadium element in the positive electrode film layer may be in multiple valence states. Vanadium with a valence of +5 (V⁵⁺) may be doped at a phosphorus element site. Due to its large radius, it may cause lattice distortion and expand a diffusion channel of lithium ions, thereby improving the ionic conductivity of the positive electrode active material and improving the kinetic performance of the battery. Vanadium with a valence of +3 (V³⁺) may be doped at a transition metal site to generate lithium vacancies through charge compensation, thereby improving the electronic conductivity of the positive electrode active material. In addition, the improved distribution uniformity of the vanadium element in lithium-containing transition metal phosphate particles helps to further improve the kinetic performance and reaction uniformity of the positive electrode film layer, thereby further improving the kinetic performance and cycle performance of the battery cell.

The mass content of the vanadium element in the above range is helpful to improve the kinetic performance of the positive electrode plate and the kinetic performance of the thick-coated lithium-containing transition metal phosphate battery. At the same time, the synergistic effect of the titanium element, the vanadium element and carbon nanotubes in the positive electrode film layer helps to form a good three-dimensional network, further improving the electronic conductivity and ionic conductivity of the positive electrode film layer, thereby further improving the kinetic performance of the thick-coated lithium-containing transition metal phosphate battery.

In any embodiment, the positive electrode film layer further includes a conductive agent, and based on the total area of a cross-section of the positive electrode film layer along the thickness direction of the electrode plate, the area proportion of an agglomeration region of the conductive agent is 0.5% to 2.5%.

Based on the total area of the cross-section of the positive electrode film layer along the thickness direction of the electrode plate, the area proportion of the agglomeration region of the conductive agent is within the above range, indicating that the conductive agent is evenly dispersed in the positive electrode film layer and is easy to form a uniform conductive network, which is particularly beneficial to reducing the problem of kinetic degradation caused by the increase of an ion transmission path in the thick-coated film layer, reducing the local polarization and even lithium plating problems generated by the battery during the cycle process, and improving the cycle life of the battery.

At the same time, studies have shown that large-sized particles in the lithium-containing transition metal phosphate particles are prone to rebound. The agglomeration area of the conductive agent within the above range can suppress the rebound of the lithium-containing transition metal phosphate particles with the help of the uniform distribution of the conductive agent, form mechanical constraints on the particles and even the film layer, improve the cohesion of the film layer, reduce the powder loss and falling-off of the film layer, and improve the cycle life of the battery.

In any embodiment, the positive electrode film layer further includes a conductive agent, and based on the total area of a cross-section of the positive electrode film layer along the thickness direction of the electrode plate, the area proportion of an agglomeration region of the conductive agent is 1.5% to 2.5%.

The area proportion of the agglomeration region of the conductive agent is further within the above range, indicating that the conductive agent is more evenly distributed in the positive electrode film layer and the content of the conductive agent is relatively low. While improving the kinetic performance of the positive electrode film layer, it helps to reduce the occupied space of the positive electrode active material due to excessive conductive agents, thereby further improving the volumetric energy density of the battery while improving the battery kinetic performance.

In any embodiment, the conductive agent includes carbon nanotubes, and the carbon nanotubes include one or more of single-walled carbon nanotubes, few-walled carbon nanotubes, and multi-walled carbon nanotubes.

Since the carbon nanotubes have a one-dimensional structure, they can form a network structure in the positive electrode film layer. On the one hand, the high elastic modulus of the carbon nanotubes enables its network structure to not only serve as a bridge for stress propagation, but also has a binding effect on the thick-coated positive electrode film layer, inhibiting the rebound of the lithium-containing transition metal phosphate particles, effectively alleviating stress concentration, reducing the risk of film layer falling-off, and thus alleviating the problem of battery capacity plummeting; and on the other hand, the excellent conductivity of the carbon nanotubes makes its network structure an efficient electron transmission channel. Even if there is local film layer falling-off, the thick electrode plate can still maintain high electron transmission efficiency in the in-plane direction and thickness direction, thereby delaying the occurrence of the capacity plummeting problem and further improving the battery's dynamic performance and cycle life.

In any embodiment, the conductive agent further includes conductive carbon black.

The conductive carbon black has a high specific surface area and thus has good liquid retention capacity. The thick electrode plate has a large expansion force during the cycle, which makes the electrolyte solution easy to squeeze out. The distribution of the conductive carbon black in the positive electrode film layer is conducive to improving the liquid retention capability of the thick electrode plate, further alleviating the phenomenon of battery capacity plummeting during the cycle, and improving the cycle life of the battery.

In any embodiment, the agglomeration region of the conductive agent includes carbon nanotubes and conductive carbon black.

Researchers found that the carbon nanotubes are prone to agglomeration due to their high surface energy, resulting in uneven dispersion in the positive electrode film layer and the inability to form an effective carbon nanotube network structure. The surface energies of the conductive carbon black and the carbon nanotubes are relatively close, and the conductive carbon black can be adsorbed on the surfaces of the carbon nanotubes to form a physical barrier, thereby increasing the resistance of carbon nanotube agglomeration, reducing direct contact between the carbon nanotubes, and thus inhibiting agglomeration and improving the distribution uniformity of the carbon nanotubes in the positive electrode film layer. On the one hand, this helps to improve the conductivity of the thick-coated positive electrode film layer and improve the dynamic performance of the battery; and on the other hand, it helps to exert the binding effect of the carbon nanotubes on the positive electrode film layer, reduce the risk of falling-off of the thick-coated positive electrode film layer, and further improve the dynamic performance and cycle life of the battery. In addition, the agglomeration of the carbon nanotubes in the conductive agent agglomeration area will also lead to blockage of local ion transmission pathways in the conductive agent agglomeration area. The combination with the conductive carbon black can improve the lithium ion transmission capability in this region, reduce local polarization, and further improve the cycle stability of the battery.

In any embodiment, based on the mass of the positive electrode film layer, the mass content C1 of the carbon nanotubes satisfies: 0<C1≤2.5%, and the mass content C2 of the conductive carbon black satisfies: 0<C2≤2.5%.

The mass contents of the carbon nanotubes and the conductive carbon black are within the above ranges, which can effectively alleviate the agglomeration of the carbon nanotubes and form a good conductive network structure, thereby effectively reducing the stress concentration of the positive electrode film layer, improving the liquid retention rate of the positive electrode plate during long cycles, further reducing the risk of electrode plate film layer falling-off and the degree of polarization, improving the battery's kinetic performance while taking into account the capacity plummeting problem and improving the battery's cycle life.

In any embodiment, the positive electrode film layer further includes a dispersant, and the dispersant includes hydrogenated nitrile rubber (HNBR).

HNBR is obtained by hydrogenating and saturating the double bonds of nitrile rubber. Its highly saturated main chain structure gives it excellent oil resistance, heat resistance and aging resistance. This allows it to remain stable in different environments and systems when used as a dispersant, making it less likely to degrade or deteriorate, thereby effectively exerting its dispersing effect. HNBR molecular chains contain both polar nitrile groups and non-polar hydrocarbon segments. The polar nitrile group may interact with some polar substances or particle surfaces, such as being adsorbed on the surfaces of dispersed particles through hydrogen bonds, electrostatic effects, etc.; and the non-polar hydrocarbon segments have good lipophilicity and can stretch and disperse well in non-polar or weakly-polar media, so that the particles are evenly dispersed in the media.

When HNBR is adsorbed on the surfaces of particles in a slurry, its long-chain molecules will form a physical barrier around the particles, preventing the particles from approaching and aggregating with each other, so that the particles remain a relatively independent dispersed state in the systems. At the same time, HNBR may reduce the surface tension between the dispersion medium and the dispersed particles, making the particles easier to wet by the medium, thereby promoting the dispersion of the particles in the medium. At the same time, it can also reduce the interfacial energy between the particles and reduce the aggregation of the particles driven by interfacial energy. Further, when the slurry is dried to form a film, an elastic network structure of HNBR can buffer the shrinkage stress caused by solvent volatilization, reduce the re-aggregation of the conductive agent due to capillary force in this process, reduce the area proportion of the conductive agent agglomeration region, and improve the battery's dynamic performance and cycle life.

In any embodiment, based on the mass of the positive electrode film layer, the mass content of the dispersant is 0.5% to 2%.

The mass content of the dispersant is within the above range, which can achieve uniform dispersion of particles in the positive electrode film layer while maintaining a high loading capacity of the positive electrode film layer, reduce stress concentration in the thick-coated lithium-containing transition metal phosphate positive electrode film layer, and effectively alleviate the problem of battery capacity plummeting.

In any embodiment, a porosity of the negative electrode film layer is 14% to 28%.

The porosity of the positive electrode film layer is within the above range, and the positive electrode film layer has good electrolyte solution infiltration rate and tortuosity, which is conducive to the diffusion of lithium ions in liquid and solid phases, helps to reduce the concentration polarization of thick electrode plates, and improves the dynamic performance of the battery. At the same time, it helps to alleviate the volume expansion of thick-coated electrode plates during the cycle, reduce the mechanical stress of the film layer and reduce stress concentration, thereby reducing the risk of film layer falling-off of the thick-coated electrode plates.

Especially in thick-coated soft-pack batteries, a gap between a shell and an electrode plate is small, the volume occupancy of the film layer is large, the electrolyte solution holding volume is reduced, and the porosity of the positive electrode film layer is within the above range, which helps to improve the liquid retention rate of the battery cell and improve the battery's dynamic performance.

In any embodiment, the battery cell also includes a separator arranged between the positive electrode plate and the negative electrode plate, the separator includes a base membrane, a ceramic layer arranged on at least one side of the base membrane and an adhesive layer arranged on the side of the ceramic layer away from the base membrane, the adhesive layer is a continuous layer with a porous structure, and the adhesive layer includes a vinylidene fluoride polymer.

In any embodiment, the battery cell also includes a separator arranged between the positive electrode plate and the negative electrode plate, the separator includes a base membrane, ceramic layers arranged on two sides of the base membrane and an adhesive layer arranged on the side of the ceramic layer located on at least one side away from the base membrane.

In any embodiment, the battery cell also includes a separator arranged between the positive electrode plate and the negative electrode plate, the separator includes a base membrane, ceramic layers arranged on two sides of the base membrane and adhesive layers arranged on the sides of the ceramic layers located on two sides away from the base membrane.

In any embodiment, the vinylidene fluoride polymer includes one or more of polyvinylidene fluoride (PVDF) and polyvinylidene fluoride-hexafluoropropylene copolymer (PVDF-HFP).

In any embodiment, the vinylidene fluoride polymer includes polyvinylidene fluoride (PVDF).

In the prior art, an adhesive layer of a separator usually uses water-based PVDF, which presents an island-like structure in the separator. On the one hand, this is conducive to providing gaps for the expansion of a cell, and on the other hand, it is easy to manufacture; however, the contact area between the adhesive layer of such a separator and an electrode plate is small, and the bonding force is weak.

The separator provided in the example of the present application uses the continuous layer with the porous structure as the adhesive layer. Its porous structure provides space for the expansion of thick-coated battery cells, thereby improving their stability. At the same time, compared with the adhesive layer in the prior art, its bonding area with the electrode plate is larger, thereby making the bonding between the separator and the electrode plate more firm and uniform. Further, when the positive electrode film layer rebounds, it is beneficial to maintain the interface contact between the separator and the positive electrode film layer, thereby reducing the probability of film layer falling off.

Compared with wound battery cells, the extrusion between the separator and the electrode plate in a stacked electrode assembly is smaller, and the separator and the electrode plate are prone to relative displacement, which disturbs the film layer and makes the film layer prone to powder loss or falling off, in addition, it may also cause the positive and negative electrodes to overlap with each other, increasing the risk of internal short circuit in the battery cell. Therefore, the separator provided in the examples of the present application is particularly suitable for the stacked electrode assembly. The increased bonding force between the porous adhesive layer and the electrode plate helps to improve the bonding force between the separator and the electrode plate and reduce the relative displacement between the separator and the electrode plate. This helps to reduce the disturbance to the positive electrode film layer and the probability of film layer falling off, and also helps to reduce the risk of short circuit of the battery cell caused by overlapping of the positive and negative electrodes.

In summary, when the vinylidene fluoride polymer in the adhesive layer of the example of the present application is selected from the above materials, it helps to form the continuous and uniform porous adhesive layer. First, the bonding force between the adhesive layer and the electrode plate is improved and evenly distributed, which helps to reduce stress concentration in thick-coated lithium-containing transition metal phosphate positive electrode film layers and reduce the risk of film layer falling-off, thereby helping to further improve the cycle life of the battery; secondly, the adhesive layer is stably bonded to the positive electrode plate or the negative electrode plate, which helps to reduce the direct contact between the positive electrode plate and the negative electrode plate due to the relative displacement of the electrode plate and the separator, reduces the risk of internal short circuit, and helps to improve the safety performance of the battery; and thirdly, the porous adhesive layer helps to maintain the porosity of the separator, reserves space for the expansion of the battery cell, and further improves the cycle life of the battery.

Ceramic particles are flame retardant and have a high hardness value. They are not easily deformed by heat and therefore have excellent dimensional stability. The low thermal conductivity of ceramic materials can further prevent certain thermal runaway points in the battery from expanding into overall thermal runaway, thereby improving the safety performance of the battery cell.

In any embodiment, the thickness of the base membrane in the separator is 7-9 μm.

In any embodiment, the single-side thickness of the ceramic layer in the separator is 2-4 μm.

In any embodiment, the single-side thickness of the adhesive layer in the separator is 1-5 μm.

If the thickness of the adhesive layer is too low, the gap space in the separator is small, and the bonding force between the separator and the electrode plate is low. On the one hand, the stress increases after the film layer expands and the probability of film layer falling-off increases, affecting the cycle life of the battery; and on the other hand, the probability of positive and negative electrode short circuit increases, thereby affecting the safety performance of the battery. If the thickness of the adhesive layer is too large, a space utilization rate on the battery is high, thereby affecting the volumetric energy density of the battery. In the examples of the present application, the thickness of the adhesive layer is within the above range, which helps to take into account the cycle life, safety performance and volumetric energy density of the battery.

In any embodiment, the positive electrode film layer is provided with a primer layer in the bottom region near the positive electrode current collector. The primer layer includes a conductive agent and a binder. The conductive agent includes carbon nanotubes and conductive carbon black. The binder includes a vinylidene fluoride polymer.

In any embodiment, the thickness of the primer layer is 0.5 μm to 5 μm.

The primer layer provided in the example of the present application helps to improve the bonding force between the positive electrode film layer and the positive electrode current collector and alleviate the stress concentration at large particles, thereby reducing the probability of falling-off of the positive electrode film layer and improving the cycle stability of the battery. At the same time, compared with the direct contact between the positive electrode current collector and the positive electrode film layer, the contact area between the primer layer and the positive electrode film layer is increased, which helps to increase the area of electron transmission between the current collector and the positive electrode film layer, thereby reducing the internal resistance of the electrode plate and improving the dynamic performance of the battery.

In any embodiment, the battery cell includes a shell, and a stacked electrode assembly is accommodated in the shell. A dimension of the shell in a length direction is L₁, a dimension of the shell in a width direction is W₁, and a dimension of the shell in a thickness direction is H₁, wherein 450 mm≤L₁≤1300 mm, 100 mm≤W₁≤150 mm, and 14 mm≤H₁≤22 mm.

In any embodiment, the dimension of the shell in the length direction is L₁, wherein 450 mm≤L₁≤650 mm.

When the dimension L₁ of the shell in the length direction satisfies 450 mm≤L₁≤650 mm, the length of the battery cell is shorter, which helps to shorten a current diffusion path and reduce the internal resistance of the electrode plate, thereby reducing the heat generation of the battery and improving its dynamic performance; in addition, the shorter shell length helps to shorten a diffusion path of the electrolyte solution during the infiltration process, improve the infiltration rate and uniformity of the electrolyte solution, further promote the uniformity of lithium ion insertion and extraction during the cycle, alleviate stress concentration, reduce the risk of film layer falling-off, and improve the cycle stability of the battery cell.

In any embodiment, the dimension of the shell in the length direction is L₁, wherein 900 mm≤L₁≤1300 mm.

When the dimension L₁ of the shell in the length direction satisfies 900 mm≤L₁≤1300 mm, the size of the battery cell is longer, which helps to reduce the volume ratio of the shell in the battery cell and increase the load ratio of the active material. At the same time, longer battery cells can reduce the number of batteries required in a battery module, simplify the structural design of the battery module, and reduce the number and complexity of structural parts in the module, thereby improving the space utilization of a battery pack, and further helping to improve the volumetric energy density of the battery cells.

In any embodiment, the material of the shell is a soft pack material, and the soft pack material includes an aluminum-plastic composite film.

In any embodiment, the material of the shell includes a composite film formed by aluminum and one or more of polypropylene (PP), polybutylene terephthalate (PBT), polybutylene succinate (PBS), nylon, polyethylene terephthalate (PET), and polyethylene (PE).

The soft-pack material has a high elongation, so its shell is thinner and softer, which helps to improve the space utilization of the battery cell and thus increase the energy density of the battery cell. In addition, the high barrier properties of aluminum can effectively reduce the penetration of water and oxygen into the battery, reduce the decomposition of the electrolyte solution and the oxidation degree of the electrode material, thereby increasing the battery life.

In any embodiment, at 25 °C, the capacity of the battery cell is 105 Ah to 300 Ah.

In any embodiment, at 25 °C, the capacity of the battery cell is 150 Ah to 190 Ah.

A second aspect of the present application provides a battery apparatus, including the battery cell provided in the first aspect of the present application.

A third aspect of the present application provides an electrical apparatus, including the battery apparatus provided in the second aspect, wherein the battery apparatus is configured to provide electric energy.

A fourth aspect of the present application provides an energy storage apparatus, including the battery apparatus provided in the second aspect, wherein the battery apparatus is configured to store electric energy.

### BRIEF DESCRIPTION OF DRAWINGS

FIG. 1 is a schematic diagram of a separator in an embodiment of the present application.

FIG. 2 is a schematic diagram of a separator in the prior art.

FIG. 3 is a schematic diagram of a surface form of an adhesive layer in an embodiment of the present application.

FIG. 4 is a schematic diagram of a soft-pack laminated battery in the present application.

FIG. 5 is a schematic diagram of an electrical apparatus in an embodiment of the present application.

### DESCRIPTION OF REFERENCE NUMERALS

5 battery cell; 50 shell; 20 separator; 201 base membrane; 202 ceramic layer; 203 adhesive layer; X length direction; Y width direction; and Z thickness direction.

### DETAILED DESCRIPTION

Embodiments of a battery cell, a battery apparatus, an electrical apparatus and an energy storage apparatus of the present application are specifically disclosed below with appropriate reference to the detailed description of the accompanying drawings. However, there are cases where unnecessary detailed descriptions are omitted. For example, there are cases where detailed descriptions of well-known items and repeated descriptions of actually identical structures are omitted. This is to avoid unnecessary redundancy in the following descriptions and to facilitate understanding by those skilled in the art. In addition, the accompanying drawings and subsequent descriptions are provided for those skilled in the art to fully understand the present application, and are not intended to limit the subject matter recited in the claims.

The “ranges” disclosed in the present application are defined in the form of lower and upper limits. A given range is defined by selecting a lower limit and an upper limit, and the selected lower and upper limits define the boundaries of the particular range. The range defined in this way may include or may not include end values, and may be arbitrarily combined, that is, any lower limit can be combined with any upper limit to form a range. For example, if the ranges 60-120 and 80-110 are listed for specific parameters, it is understood that the ranges 60-110 and 80-120 are also expected. In addition, if the listed minimum range values are 1 and 2 and if the listed maximum range values are 3, 4, and 5, the following ranges can all be expected: 1-3, 1-4, 1-5, 2-3, 2-4, and 2-5. In the present application, unless otherwise specified, the numerical range “a-b” represents an abbreviated representation of any combination of real numbers between a and b, wherein a and b are both real numbers. For example, the numerical range “0-5” indicates that all real numbers between “0-5” have been listed herein, and “0-5” is only a shortened representation of these numerical combinations. In addition, when a parameter is expressed as an integer greater than or equal to 2, it is equivalent to disclosing that the parameter is, for example, an integer of 2, 3, 4, 5, 6, 7, 8, 9, 10, 11, 12, and the like.

Unless otherwise specifically stated, all embodiments and optional embodiments of the present application may be combined with each other to form new technical solutions, and such technical solutions should be considered as being included in the disclosure of the present application.

Unless otherwise specifically stated, all technical features and optional technical features of the present application may be combined with each other to form new technical solutions, and such technical solutions should be considered as being included in the disclosure of the present application.

Unless otherwise specified, all steps of the present application may be performed sequentially or randomly, and preferably sequentially. For example, the method includes steps (a) and (b), which means that the method may include steps (a) and (b) performed in order, or may include steps (b) and (a) performed in order. For example, the reference to the method may further include step (c), meaning that step (c) may be added to the method in any order, for example, the method may include steps (a), (b) and (c), or may include steps (a), (c) and (b), or may include steps (c), (a) and (b), and so on.

In the present application, the terms “a plurality of” and “multiple” refer to two or more.

Unless otherwise stated, the terms used in the present application have the well-known meanings commonly understood by those skilled in the art.

Unless otherwise stated, numerical values of parameters mentioned in the present application may be measured using various testing methods commonly used in the art. For example, the numerical values may be measured according to testing methods given in the embodiments of the present application. Unless otherwise stated, all parameters are tested at 25 °C.

In the examples of the present application, the battery apparatus may include one or more battery cell assemblies for providing voltage and capacity. The battery cell assembly may include a plurality of soft-pack battery cells, and the plurality of soft-pack battery cells are connected by series connection, or parallel connection, or parallel-series connection through a busbar component. For example, the battery cell assembly is generally formed by arranging the plurality of soft-pack battery cells. The battery cell assembly may be a battery module, which is an independent module formed by arranging and fixing the plurality of soft-pack battery cells. As an example, the battery module may be formed by bundling the plurality of battery cells with cable ties.

The battery apparatus may be a battery pack. The battery pack includes a box body and one or more battery cell assemblies. The battery cell assemblies are accommodated in the box body. Each battery cell assembly may be a battery module, and may be accommodated in the box body by fixing the battery module in the box body; and each battery cell assembly may also be accommodated in the box body by directly fixing the plurality of soft-pack battery cells in the box body.

In an example of the present application, the box body may include a first box body and a second box body. The first box body and the second box body are fastened together to form an enclosure space inside the box body to accommodate the battery cell assembly. Enclosure here means covering or closing, and may be sealed or unsealed. The first box body may be a top cover or a bottom plate. For example, the box body may include a top cover, a frame, and a bottom plate. The top cover and the bottom plate are respectively connected to the frame, so that the enclosure space is formed inside the box body to accommodate the battery cell assembly.

In an example of the present application, the box body may serve as a part of a chassis structure of a vehicle. For example, a part of the box body may become at least a portion of a floor of the vehicle, or a part of the box body may become at least a part of a cross beam and a longitudinal beam of the vehicle.

In the example of the present application, the battery cell may be a secondary battery. The secondary battery refers to a battery cell that, after being discharged, can activate an active material by charging for continued use. The battery cell may be a lithium-ion battery. The battery cell may be a flat body.

The battery mentioned in the example of the present application may be a single physical module including one or more battery cells to provide a higher voltage and capacity. For example, the battery mentioned in the present application may include a battery cell, a battery module, a battery pack, or the like.

The battery cell is a smallest unit that makes up the battery, and capable of achieving charging and discharging functions separately.

When a plurality of battery cells are provided, the plurality of battery cells are connected in series, in parallel, or in series-parallel through a busbar component. In some embodiments, the battery may be a battery module. When there are a plurality of battery cells, the plurality of battery cells are arranged and fixed to form a battery module. In some embodiments, the battery may be a battery pack. The battery pack includes a box body and a battery cell. The battery cell or the battery module is accommodated in the box body. In some embodiments, the box body may serve as a part of a chassis structure of the vehicle. For example, a part of the box body may become at least a portion of a floor of the vehicle, or a part of the box body may become at least a part of a cross beam and a longitudinal beam of the vehicle.

In some embodiments, the battery may be an energy storage apparatus. The energy storage apparatus includes an energy storage container, an energy storage cabinet, and the like.

In some embodiments, the battery cell may be assembled into a battery module, the number of battery cells included in the battery module may be multiple, and a specific number may be adjusted according to the application and capacity of the battery module.

In some embodiments, the aforementioned battery module may further be assembled into a battery pack, and the number of battery modules included in the battery pack may be adjusted according to the application and capacity of the battery pack.

The battery cell includes an electrode assembly and an electrolyte.

The electrode assembly usually includes a positive electrode plate and a negative electrode plate. The negative electrode plate is an electrode that absorbs or lithiates lithium ions during charging and releases or delithiates lithium during discharging. The positive electrode plate is an electrode that releases or delithiates lithium ions during charging and absorbs or lithiates lithium during discharging.

Lithium-containing transition metal phosphates as positive electrode active materials have the advantages of high safety, long cycle life, low cost and high high-temperature stability, but their intrinsic gram capacity is significantly lower than that of ternary materials. To make up for this energy density shortcoming, the applicant found that adopting a thick coating strategy (i.e., a strategy to increase the content of active materials per unit area, often with a larger film layer thickness) can increase the load of positive electrode active materials in a battery, thereby improving the energy density of the battery; however, during the long cycle of the battery, a thick-coated battery cell produces a greater volume expansion, resulting in increased internal stress, making it easy for an electrode plate to lose film layer powder or even fall off in the later stage of the long cycle. On the one hand, the falling-off of the film layer brings about the loss of positive electrode active materials, causing the battery capacity to decay rapidly (capacity plummeting); on the other hand, it forms an “island” effect, that is, isolated areas are formed between some active material particles or between particles and conductive agents, which cannot form good electrical contact and cannot achieve effective electron transmission, and thus cannot participate in the battery's charge and discharge reactions. At the same time, this part of the materials affects ion transmission, increases the internal resistance of the battery, causes local overheating of the battery and increases the risk of thermal runaway, seriously affecting the battery's service life. Therefore, how to achieve long-term stable maintenance of battery capacity while improving battery energy density remains a technical problem that urgently needs to be solved.

A first aspect of the present application provides a battery cell. The battery cell includes a stacked electrode assembly, the stacked electrode assembly includes a positive electrode plate and a negative electrode plate, the positive electrode plate includes a positive electrode current collector and a positive electrode film layer disposed on at least one side of the positive electrode current collector, and the positive electrode film layer includes lithium-containing transition metal phosphate particles with a carbon material disposed on at least a portion of surfaces. When the battery cell is fully discharged, the positive electrode plate has a compacted density of 2.3 g/cm³ to 2.6 g/cm³; a single-side surface density of the positive electrode film layer is 0.25 g/1540.25 mm² to 0.45 g/1540.25 mm²; based on a total area of particles in a cross-section of the positive electrode film layer along a thickness direction of the electrode plate, an area proportion of particles having a particle size R1 satisfying R1≥1000 nm is 12% to 50%; and in the cross-section of the positive electrode film layer along the thickness direction of the electrode plate, a distribution uniformity of the particles having the particle size R1 satisfying R1≥1000 nm is less than or equal to 5%.

Compared with ternary materials, lithium-containing transition metal phosphates have a more stable structure and are less likely to break under high pressure. During the electrode plate compaction process, the lithium-containing transition metal phosphates need to withstand higher pressures in order to increase the compacted density. However, studies have shown that when a battery cell is fully discharged, if the compacted density of the positive electrode plate is greater than 2.6 g/cm³, the sheet will have over-voltage, resulting in large stress concentration, which can easily cause the positive electrode film layer to fall off during the cycle; when a battery cell is fully discharged, if the compacted density of the positive electrode plate is less than 2.3 g/cm³, the positive electrode film layer particles will not be tightly connected, increasing the internal resistance of a battery and reducing the energy density of the battery cell. The single-side surface density of the positive electrode film layer is less than 0.25 g/1540.25 mm², and the content of positive electrode active materials loaded in the battery cell is low, which cannot effectively improve the energy density of the battery. The single-side surface density of the positive electrode film layer is greater than 0.45 g/1540.25 mm², which will make the positive electrode film layer too thick. The stress distribution of the positive electrode film layer is uneven during the compaction process, and local stress concentration is likely to cause the film layer to fall off. Controlling the compacted density of the positive electrode plate to 2.3 g/cm³ to 2.6 g/cm³ and the single-side surface density of the positive electrode film layer to 0.25 g/1540.25 mm² to 0.45 g/1540.25 mm² can improve the energy density while maintaining a low risk of falling off of the positive electrode film layer.

The applicant further discovered that the expansion volume of thick-coated electrode plates increases significantly during battery charging and discharging, making it easy for the thick-coated electrode plates to experience film layer falling-off in the later stages of long cycles, where large particles in the film layer are likely to be the starting point for film layer falling-off. Studies have shown that large particles are prone to cause stress concentration and cracks during the film layer compaction process. However, if the content of large particles in the positive electrode film layer is too low, it will limit the increase in the compacted density of the positive electrode film layer. Studies have shown that the compacted density of the positive electrode plate is controlled at 2.3 g/cm³ to 2.6 g/cm³, and the single-side surface density of the positive electrode film layer is 0.25 g/1540.25 mm² to 0.45 g/1540.25 mm². Based on the total area of the particles in the cross-section of the positive electrode film layer along the thickness direction of the electrode plate, the area proportion of particles having a particle size R1 satisfying R1≥1000 nm is less than 12%, which will reduce the energy density of the battery. Based on the total area of the particles in the cross-section of the positive electrode film layer along the thickness direction of the electrode plate, the area proportion of particles having a particle size R1 satisfying R1≥1000 nm is more than 50%, which will easily cause stress concentration during the film layer compaction process and uneven expansion during the cycle, thereby causing the film layer to shed powder or even fall off. In the cross-section of the positive electrode film layer along the thickness direction of the electrode plate, the distribution uniformity of particles having the particle size R1 satisfying R1≥1000 nm is greater than 5%, which will increase the stress concentration during the compaction process of the film layer, further increase the uneven expansion during the cycle, and increase the risk of film layer powder loss and falling-off.

In an example of the present application, the battery cell includes a stacked electrode assembly. When the battery cell is fully discharged, the compacted density of the positive electrode plate is 2.3 g/cm³ to 2.6 g/cm³, the single-side surface density of the positive electrode film layer is 0.25 g/1540.25 mm² to 0.45 g/1540.25 mm², and based on the total area of particles in a cross-section of the positive electrode film layer along the thickness direction of the electrode plate, the area proportion of particles having a particle size R1 satisfying R1≥1000 nm is 12% to 50%, and in a cross-section of the positive electrode film layer along the thickness direction of the electrode plate, the distribution uniformity of particles having a particle size R1 satisfying R1≥1000 nm is less than or equal to 5%. First of all, compared with wound cells, stacked electrode assembly have no corner areas, which can effectively improve the space utilization of the battery, thereby increasing the volumetric energy density; and the lack of corner areas helps to reduce stress concentration, reduce the probability of film layer falling-off, and reduce the risk of battery capacity plummeting. Secondly, by controlling the compacted density and the single-side coating surface density within the above range, it is not only beneficial to increase the loading amount of the positive electrode active material, but also to control the porosity of the positive electrode film layer within an appropriate range, thereby increasing the infiltration rate of an electrolyte solution, so that the gram capacity of the active material can be fully utilized, and further improving the volumetric energy density of the battery. In addition, the examples of the present application further help to increase the loading amount of the positive electrode active material and improve the stress distribution by controlling the content of large particles in the positive electrode film layer and their distribution uniformity, thereby alleviating the negative impact of stress concentration, thereby facilitating taking into account the capacity and cycle stability of the battery and reducing the risk of battery capacity plummeting.

In summary, the battery cells provided in the examples of the present application have good capacity and good capacity cycle stability.

In the present application, the stacked electrode assembly refers to a cell formed by laminating the positive electrode plate, the separator, and the negative electrode plate.

In the present application, the positive electrode film layer contains the lithium-containing transition metal phosphate particles, but the positive electrode film layer does not only refer to a positive electrode active material layer. Other film layers that are connected to the positive electrode active material layer and are difficult to distinguish, such as a primer layer, a liquid retention layer, etc. are collectively referred to as the positive electrode film layer.

In the present application, the lithium-containing transition metal phosphate refers to a phosphate material containing a lithium element and a transition metal element, which can be detected by any method known in the art. For example, it can be detected by combining an X-ray diffractometer (XRD) with an energy spectrum analyzer and an inductively coupled plasma mass spectrometer.

In the present application, the carbon material disposed on at least a portion of the surfaces of the lithium-containing transition metal phosphate particles can be detected by any method known in the art. As an example, by characterizing the lithium-containing transition metal phosphate particles using a combination of a transmission electron microscope and an energy spectrum analyzer, it is possible to observe the carbon material disposed on at least a portion of the surfaces of the lithium-containing transition metal phosphate particles.

In the present application, a fully discharged state refers to a state after placing a battery in a 25 °C oven environment, standing for 2 hours, maintaining the battery temperature at 25 °C, discharging the battery at a constant current of ⅓C to 2.5V, and then discharging at a constant current of 0.1 C to 2.0V.

In the present application, the compacted density of the positive electrode plate may be tested by methods known in the art. As an example, the battery is placed in the 25 °C oven environment and left to stand for 2 hours. When the battery temperature is maintained at 25 °C, the battery is discharged at a constant current of ⅓C to 2.5V and then discharged at a constant current of 0.1 C to 2.0V The battery is disassembled to obtain the positive electrode plate. A residual electrolyte solution is treated with a dimethyl carbonate solvent, and the electrode plate is dried, and cut into small discs with an area of S. The mass is obtained as W₁, and a thickness Ti of the positive electrode plate is measured using a micrometer. Then, the positive electrode film layer of the weighed electrode plate is wiped off, the mass of a current collector is weighed, and recorded as W₂, and a thickness T₂ of the current collector is measured using a micrometer. The compacted density of the positive electrode plate is PD=(W₁−W₂)/[(T₁−T₂)×S].

In some embodiments, when the battery cell is fully discharged, the compacted density of the positive electrode plate is optionally 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm³, 2.40 g/cm³, 2.41 g/cm³, 2.42 g/cm³, 2.43 g/cm³, 2.44 g/cm³, 2.45 g/cm³, 2.46 g/cm³, 2.47 g/cm³, 2.48 g/cm³, 2.49 g/cm³, 2.50 g/cm³, 2.55 g/cm³, 2.60 g/cm³ or any numerical range therebetween.

In the present application, a single-side coated surface density of the positive electrode film layer has a meaning well-known in the art, and can be tested by methods known in the art. For example, a single-side-coated and cold-pressed positive electrode plate is taken (if it is a double-side-coated positive electrode plate, a positive electrode film layer on one side may be wiped off first), punched into small discs with an area of Si, and weighed, and a weight is denoted as M₁. Then, a positive electrode film layer of the weighed positive electrode plate is wiped off, and a weight of a current collector is weighed and denoted as M₀. The single-side surface density of the positive electrode film layer=(M₁−M₀)/Si. In order to ensure the accuracy of the test results, multiple groups (e.g., 10) of to-be-tested samples may be tested, and an average value is calculated as a test result. The higher the single-side coating surface density of the positive electrode film layer, the greater the load per unit area, which helps to increase the volumetric energy density of the battery cell.

In some embodiments, the single-side coating surface density of the positive electrode film layer is optionally 0.25 g/1540 mm², 0.26 g/1540 mm², 0.27 g/1540 mm², 0.28 g/1540 mm², 0.29 g/1540 mm², 0.30 g/1540 mm², 0.31 g/1540 mm², 0.32 g/1540 mm², 0.33 g/1540 mm², 0.34 g/1540 mm², 0.35 g/1540 mm², 0.36 g/1540 mm², 0.37 g/1540 mm², 0.38 g/1540 mm², 0.39 g/1540 mm², 0.40 g/1540 mm², 0.41 g/1540 mm², 0.42 g/1540 mm², 0.43 g/1540 mm², 0.44 g/1540 mm², 0.45 g/1540 mm² or any numerical range therebetween.

In some embodiments, the single-side coating surface density of the positive electrode film layer is 0.3 g/1540.25 mm² to 0.45 g/1540.25 mm².

In some embodiments, the single-side coating surface density of the positive electrode film layer is 0.35 g/1540.25 mm² to 0.4 g/1540.25 mm².

The single-side coating surface density of the positive electrode film layer is further within the above range, which helps to further improve the capacity of the battery while taking into account the cycle performance.

In the present application, the term “particle” refers to particles with identifiable complete boundaries in the field of view of the positive electrode film layer under a certain magnification, such as 10,000 times. Defects and scratches may exist inside the particles, but complete boundaries sufficient to separate the particles cannot be recognized inside the particles. The positive electrode film layer in the present application may be either a freshly prepared positive electrode film layer or a positive electrode film layer obtained by disassembling a battery.

In the present application, a method for recognizing the particles is as follows: the positive electrode film layer is cut along the thickness direction of the electrode plate by an argon ion beam (as an example, equipment model: Leica EMTIC3XCP, working voltage: 6 kV, working duration: 6 h), and after a cross-section is exposed, a scanning electron microscope is used (as an example, equipment model: Hitachi SU8230, working voltage: 3 kV, beam current: high, probe model: U (LA100), working distance<5 mm) to observe the cross-section of the positive electrode film layer along the thickness direction of the electrode plate. A field emission scanning electron microscope is used to collect images in a secondary electron mode at non-edge positions in the cross-section of the positive electrode film layer (after observing the edge of the electrode plate under a scanning electron microscope, the field of view is adjusted to the center of a sample). Electron microscope images are taken at a magnification of 10 k times, and particles in the electron microscope images are analyzed using ImageJ software (1.46r, win64 version). A specific method of using the ImageJ software is as follows: a scanning electron microscope image to be analyzed is located; Cellpose plug-in software therein is used to recognize the particles and perform manual correction on this basis; and the ImageJ is used to read and count data. A specific method for recognizing the particles using the Cellpose plug-in software therein is as follows: a segmentation diameter parameter (diameter in a Segmentation module) is set to 15 pixels, and “runcyto3” is clicked on to perform particle recognition; and particles in the image that are not recognized by the software or are not fully recognized by the software or are recognized with errors are manually marked. The particles in the image that are not recognized by the software, not fully recognized by the software, or recognized with errors mainly include the following types: 1. the particles are too large or there are scratches on the particle surfaces, resulting in the particles being unable to be recognized or unable to be fully recognized; 2. during the argon ion beam cutting process, scratches will be generated on the particle surfaces, and during the recognition process, the software may mistakenly judge the scratches as particle boundaries, thereby causing recognition errors; 3. the particles are too small to be successfully recognized; and 4. the particles are located at the edge of the electron microscope field of view, and the interiors of the particles are penetrated by the edges, the morphology cannot be fully displayed, and a part is recognized instead of the whole, resulting in recognition errors. Manual calibration is performed on the above-mentioned particles that are not recognized or recognized with errors. A specific process is as follows: large particles that are located at the edges of the scanning electron microscope and cannot be fully displayed are deleted; whether there are gaps or scratches inside other particles that are not recognized or recognized with errors is determined, and if there is no gap or scratch inside the particles, they are determined to be one particle and manually marked according to the manually observed particle boundaries; in response to the presence of gaps or scratches inside the particles, whether the gaps or scratches penetrate the particles is determined, and if not, they are determined to be one particle and manually marked; in response to the gaps or scratches penetrating the particles, whether the gaps or scratches are linear or irregular is determined; in response to the gaps or scratches being irregular, they are determined as boundaries between the particles, and the particles are divided along the boundaries; in response to the gaps or scratches being linear, contrast comparison is performed; in response to the contrast comparison being unclear and without a sense of cracks, it is determined as a scratch and marked as one particle; and in response to the contrast comparison being strong and with a sense of cracks, it is determined as the boundary between the particles, and it is marked as two particles. After manual marking, information irrelevant to the particles in the automatic image processing process is deleted, thus completing the determination and marking of the particles in the image.

In the cross-section of the positive electrode plate along the thickness direction of the electrode plate, an area proportion of particles having a particle size R1 satisfying R1≥1000 nm can intuitively reflect a proportional relationship between an area of some particles in this particle size segment and an area of the entire particles, and reflect the area size of the particles in this particle size segment. It can be understood that the particles in the cross-section of the positive electrode film layer along the thickness direction of the electrode plate, especially the particles larger than 50 nm, mainly come from positive electrode active materials. Therefore, the example of the present application can accurately and objectively reflect the distribution of the lithium-containing transition metal phosphate particles in the positive electrode film layer by observing and counting the particle area in the cross-section of the positive electrode plate along the thickness direction of the electrode plate.

In the prior art, a laser particle size analyzer is generally used to measure the particle size of the positive electrode active material through the Malvern laser diffraction method. However, the applicant's research shows that since the lithium-containing transition metal phosphate particles are prone to agglomeration, test results obtained by the Malvern laser diffraction method based on the laser scattering principle often measure the particle size of particle agglomerates, which cannot truly reflect the particle size of the particles in the positive electrode active material, and even less can it reflect the dispersion state of the positive electrode active material in the film layer, because the dispersion degree of the positive electrode active material in the film layer will increase during the slurrying and film rolling process. The test results obtained by the Malvern laser diffraction method are affected by the particle size, specific surface area, and degree of agglomeration of the positive electrode active material. Compared with the actual dispersion in the electrode plate, the number of large particles obtained by the test is lower than the actual value, and the number of small particles is higher than the actual value. Therefore, the particle size obtained by the Malvern laser diffraction method test cannot be equivalent to or analogous to the particle size obtained by statistics in the examples of the present application.

A specific test method for the area proportion of the particles having the particle size R1 satisfying R1≥1000 nm in the cross-section of the positive electrode film layer along the thickness direction of the electrode plate is as follows: referring to the method described above in the present application, the particles in the positive electrode film layer are recognized, pictures in which particle determination and marking are completed are imported into the ImageJ software for analysis, scale setting is completed according to the scanning electron microscope images, and “Feret diameter”, “Area”, “Round” and “Solidity” analysis functions are used to perform statistical analysis on the particle size, area, sphericity and roughness of the particles in the cross-section of the positive electrode film layer along the thickness direction of the electrode plate. According to the software manual (ImageJUserGuideIJ 1.46r), the “Feret” parameter obtained by analysis represents the maximum distance between all parallel lines in the two-dimensional projection of the particle, which characterizes the particle size; and the “Area” parameter obtained represents the pixel area of the particles. Since particles with a particle size smaller than 50 nm have large errors in the statistical process and are difficult to recognize accurately, and the particle size of the conductive agent is generally smaller than 50 nm, large errors in the statistical results can be caused, particles with the particle size smaller than 50 nm will not be counted in the particle size statistics process of the present application, and the particle statistical data corresponding to AR, Round or Solidity displayed as “NaN” will be deleted. The sum of the “Area” parameters of the particles having the particle size R1 satisfying R1≥1000 nm and the sum of the “Area” parameters of all particles are calculated as the area of the particles having the particle size R1 satisfying R1≥1000 nm and the total area of the particles counted, respectively. The sum of the areas of the particles having the particle size R1 satisfying R1≥1000 nm divided by the total area of the particles counted is taken as the area proportion of the particles having the particle size R1 satisfying R1≥1000 nm in the cross-section of the positive electrode film layer along the thickness direction of the electrode plate.

In some embodiments, based on the total area of the particles in the cross-section of the positive electrode film layer along the thickness direction of the electrode plate, the area proportion of the particles having the particle size R1 satisfying R1≥1000 nm is optionally 12%, 12.11%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 34.88%, 34.89%, 34.93%, 34.97%, 35%, 36%, 36.71%, 36.73%, 36.75%, 36.83%, 36.87%, 36.92%, 37%, 38%, 39%, 40%, 41%, 42%, 43%, 44%, 45%, 46%, 47%, 48%, 49%, 49.99%, 50% or any numerical range therebetween.

In some embodiments, based on the total area of particles in a cross-section of the positive electrode film layer along the thickness direction of the electrode plate, the area proportion of the particles having the particle size R1 satisfying R1≥1000 nm is 12% to 37%.

The large particles having the particle size R1 satisfying R1≥1000 nm help to increase the compacted density of the positive electrode plate, thereby increasing the volumetric energy density of the battery cell; however, researchers have found that these large particles are prone to cause stress concentration, increasing the risk of positive electrode film layer falling-off. Therefore, the area proportion of the particles having the particle size R1 satisfying R1≥1000 nm in the cross-section of the positive electrode film layer along the thickness direction of the electrode plate is further within the range of 12% to 37%, which can not only improve the compacted density of the electrode plate, but also prevent the probability of film layer falling off from being too high. In this way, while improving the energy density of thick-coated lithium-containing transition metal phosphate batteries, it can alleviate the capacity plummeting problem and take into account the cycle life of the battery.

The distribution uniformity of the particles having the particle size R1 satisfying R1≥1000 nm in the cross-section of the positive electrode film layer along the thickness direction of the electrode plate can be tested using methods known in the art. As an example, the cross-section of the positive electrode film layer along the thickness direction of the electrode plate is divided into three layers of an equal thickness along the thickness direction of the electrode plate (when a surface of the positive electrode current collector is coated with a primer layer and then coated with a positive electrode active material layer, in the cross-section of the positive electrode film layer along the thickness direction of the electrode plate, a region from 5 μm of the positive electrode film layer close to the positive electrode current collector to a surface of the positive electrode film layer away from the positive electrode current collector is divided into three layers of an equal thickness along the thickness direction of the electrode plate), which are a lower layer close to the positive electrode current collector, an upper layer away from the positive electrode current collector, and a middle layer placed between the upper and lower layers; respectively, on the upper layer, the middle layer and the lower layer, ten non-overlapping fields of view are randomly selected, and scanning electron microscope images are taken at a magnification of 10 k; the ten scanning electron microscope images taken of each layer are imported into the ImageJ software for analysis, and according to the above-mentioned “test method for the area proportion of the particles having the particle size R1 satisfying R1≥1000 nm in the cross-section of the positive electrode film layer along the thickness direction of the electrode plate”, the area proportion of the particles having the particle size R1 satisfying R1≥1000 nm in the ten images corresponding to the upper, middle and lower layers are obtained, with a total of three values. A range of the three values of the upper layer, middle layer and lower layer is the distribution uniformity of the particles having the particle size R1 satisfying R1≥1000 nm in the cross-section of the positive electrode film layer along the thickness direction of the electrode plate, where the range is a difference between the maximum and minimum values of the three values of the upper layer, middle layer and lower layer. The smaller the distribution uniformity of the particles having the particle size R1 satisfying R1≥1000 nm in the cross-section of the positive electrode film layer along the thickness direction of the electrode plate, the more uniform the distribution of the large particles having the particle size R1 satisfying R1≥1000 nm in the positive electrode film layer, which helps to reduce the stress concentration at the large particles in the positive electrode film layer, reduce the probability of film layer falling-off, and improve the cycle performance of the battery.

In some embodiments, the distribution uniformity of the particles having the particle size R1 satisfying R1≥1000 nm in the cross-section of the positive electrode film layer along the thickness direction of the electrode plate is optionally 0.01%, 0.1%, 0.2%, 0.24%, 0.3%, 0.4%, 0.45%, 0.5%, 0.6%, 0.7%, 0.8%, 0.9%, 0.99%, 1%, 1.1%, 1.2%, 1.3%, 1.4%, 1.47%, 1.5%, 1.6%, 1.7%, 1.8%, 1.81%, 1.82%, 1.85%, 1.9%, 1.94%, 1.95%, 1.98%, 1.99%, 2%, 2.1%, 2.2%, 2.3%, 2.4%, 2.45%, 2.5%, 2.6%, 2.7%, 2.8%, 2.81%, 2.82%, 2.83%, 2.85%, 2.9%, 2.94%, 2.98%, 3%, 3.1%, 3.2%, 3.3% 3.4% 3.5% 3.6%, 3.7% 3.8%, 3.9% 4%, 4.1%, 4.2%, 4.3%, 4.4%, 4.5%, 4.6%, 4.7%, 4.8%, 4.9%, 4.91%, 5% or any numerical range therebetween.

In some embodiments, the distribution uniformity of the particles having the particle size R1 satisfying R1≥1000 nm in a cross-section of the positive electrode film layer along the thickness direction of the electrode plate is 0.2% to 2%.

In some embodiments, the distribution uniformity of the particles having the particle size R1 satisfying R1≥1000 nm in a cross-section of the positive electrode film layer along the thickness direction of the electrode plate is 0.2% to 0.9%.

The distribution uniformity of the particles having the particle size R1 satisfying R1≥1000 nm in the cross-section of the positive electrode film layer along the thickness direction of the electrode plate is 0.2% to 2%, and further within the range of 0.2% to 0.9%. This can effectively reduce the stress concentration in local areas of the film layer, so that the stress in the film layer compaction process can be evenly dispersed in the entire area of the film layer, thereby further improving the battery energy density while reducing the probability of film layer falling-off, alleviating the capacity plummeting problem of thick-coated lithium-containing transition metal phosphate batteries, and improving the battery cycle life.

In some embodiments, a single-side thickness H of the positive electrode film layer is 70 μm to 120 μm.

In some embodiments, the single-side thickness H of the positive electrode film layer is 90 μm to 120 μm.

The thickness of the positive electrode film layer can be detected by any method known in the art. As an example, the thickness of the positive electrode film layer in the cross-section of the positive electrode plate along the thickness direction is measured by a scanning electron microscope.

In some embodiments, the single-side thickness H of the positive electrode film layer is optionally 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm or any numerical range therebetween.

The single-side thickness of the positive electrode film layer being within the above range helps to increase the loading amount of the positive electrode active material in the battery, thereby increasing the capacity of the battery.

In some embodiments, the single-side thickness H of the positive electrode film layer is 100 μm to 120 μm.

Increasing the thickness of the positive electrode film layer helps to increase the loading amount of the positive electrode active material and helps to increase the capacity of the battery. However, the applicant found that when the single-side thickness of the positive electrode film layer is greater than or equal to 100 μm, during the battery cycle, the volume expansion of the positive electrode film layer is more significant, thereby generating greater stress, and the stress concentration in the positive electrode film layer is more significant. The risk of film layer falling-off increases, thereby affecting the cycle performance of the battery. In the examples of the present application, the capacity of the battery is increased by increasing the thickness of the positive electrode film layer, at the same time, based on the total area of the particles in the cross-section of the positive electrode film layer along the thickness direction of the electrode plate, the area proportion of the particles having the particle size R1 satisfying R1≥1000 nm is controlled, in the cross-section of the positive electrode film layer along the thickness direction of the electrode plate, the distribution uniformity of the particles having the particle size R1 satisfying R1≥1000 nm is controlled, the content of the large particles in the positive electrode film layer is controlled to be within the reasonable range and their distribution uniformity is improved, so that the stress concentration at the large particles is alleviated, thereby improving the battery capacity while taking into account the cycle performance of the battery.

In some embodiments, in the cross-section of the positive electrode film layer along the thickness direction of the electrode plate, in a cumulative distribution curve of sphericity area of the particles having the particle size R1 satisfying R1≥1000 nm, the median sphericity L_{R1A50} is 0.6 to 0.8.

In the present application, a specific test method for the sphericity of the particles having the particle size R1 satisfying R1≥1000 nm in the cross-section of the positive electrode film layer along the thickness direction of the electrode plate is as follows: referring to the method described above in the present application, the particles in the positive electrode film layer are recognized, pictures in which particle determination and marking are completed are imported into the ImageJ software for analysis, scale setting is completed according to the scanning electron microscope images, and “Feret diameter” and “Round” analysis functions are used to perform statistical analysis on the particle size and sphericity of the particles in the cross-section of the positive electrode film layer along the thickness direction of the electrode plate. According to the software manual (ImageJUserGuideIJ 1.46r), the “Feret” parameter obtained by analysis represents the maximum distance between all parallel lines in the two-dimensional projection of the particle, which characterizes the particle size; and according to the software manual (ImageJUserGuideIJ 1.46r), the “Round” parameter obtained by analysis represents the ratio of the pixel area of the particle to the area of a circle with the fitted major diameter as the diameter, which can be used to characterize the sphericity of the particle. The closer the particle is to a sphere, the closer the ratio of the pixel area to the area of the circle with the fitted major diameter as the diameter is to 1. Therefore, the “Round” parameter of the particles obtained by analysis is used to characterize the sphericity of the particles. The sphericities of at least 1000 particles having a particle size R1 satisfying R1≥1000 nm are arranged in an ascending order, and a cumulative distribution curve of the sphericities of the positive electrode film layer particles is obtained with the sphericity as the horizontal axis and a cumulative area proportion as the vertical axis. L_{R1A50} is a sphericity L value corresponding to a cumulative area proportion of 50% on the vertical axis in the cumulative distribution curve of the sphericity L value of the particles having the particle size R1 satisfying R1≥1000 nm.

Those skilled in the art can adjust the sphericity of the particles by any known process. As an example, the sphericity of the particles can be adjusted through processes such as grinding, polishing, chemical etching, mechanical stirring, extrusion, coating, granulation, and adding of surfactants, and by adjusting the parameters of each process.

It is understandable that the lithium-containing transition metal phosphate particles often require high-temperature sintering. As the grain boundaries melt and the particles grow, the sphericity of the particles will decrease. When, based on the total area of the particles in the cross-section of the positive electrode film layer along the thickness direction of the electrode plate, an area proportion of the particles having the particle size R1 satisfying R1≥1000 nm is 12% to 50%, the median sphericity of the particles will often not exceed 0.8.

In some examples, in the cross-section of the positive electrode film layer along the thickness direction of the electrode plate, in the cumulative distribution curve of sphericity area of the particles having the particle size R1 satisfying R1≥1000 nm, L_{R1A50} is optionally a numerical range between any two of 0.6, 0.62, 0.63, 0.64, 0.65, 0.66, 0.67, 0.68, 0.7, 0.72, 0.74, 0.75, 0.76, 0.77, 0.78, 0.79, and 0.8.

In the examples of the present application, in the cross-section of the positive electrode film layer along the thickness direction of the electrode plate, L_{R1A50} of the particles having the particle size R1 satisfying R1≥1000 nm is within the above range. The particles having the particle size R1 satisfying R1≥1000 nm have high roundness, which helps to improve the slippage of the particles in the positive electrode film layer, reduce stress concentration during the compaction of thick-coated film layers, and reduce the probability of film layer falling-off due to local stress concentration during long cycles of the positive electrode film layer. This further improves the volumetric energy density of the lithium-containing transition metal phosphate battery while improving the capacity plummeting problem of the battery cell and extending the cycle life.

In some embodiments, in the cross-section of the positive electrode film layer along the thickness direction of the electrode plate, in the cumulative distribution curve of sphericity area of the particles having the particle size R1 satisfying R1≥1000 nm, the median sphericity L_{R1A50} is 0.65 to 0.75.

In some embodiments, in the cross-section of the positive electrode film layer along the thickness direction of the electrode plate, in a cumulative distribution curve of sphericity area of the particles having the particle size R1 satisfying R1≥1000 nm, the median sphericity L_{R1A50} is 0.67 to 0.75.

In the cross-section of the positive electrode film layer along the thickness direction of the electrode plate, in the cumulative distribution curve of sphericity area of the particles having the particle size R1 satisfying R1≥1000 nm, the median sphericity L_{R1A50} is further within a range of 0.65 to 0.75, and furthermore within the range of 0.67 to 0.75, which helps to further extend the cycle life of thick-coated lithium-containing transition metal phosphate batteries.

In some embodiments, in a cumulative distribution curve of degree of graphitization C value of the positive electrode film layer obtained by a laser microscopic confocal Raman spectrometer in a surface scanning mode, a median C₅₀ of the degree of graphitization is greater than or equal to 0.95 and less than or equal to 1.2; wherein the degree of graphitization C value is I_{G}/I_{D}, I_{G} represents the G-band intensity of the Raman spectrum at 1580±100 cm⁻¹, and I_{D} represents the D-band intensity of the Raman spectrum at 1350±100 cm⁻¹.

In the present application, the cumulative distribution curve of degree of graphitization C value refers to a curve obtained by arranging at least 100 obtained C values in an ascending order, with the degree of graphitization as the horizontal axis and a cumulative number proportion as the vertical axis. C₅₀ is a C value corresponding to a cumulative number proportion of 50% of the vertical axis in the cumulative distribution curve of degree of graphitization C value. Compared with a point value, the median C₅₀ of the degree of graphitization can reflect the overall degree of graphitization of the particles in the positive electrode film layer, that is, the degree of slippage; and compared with a mean value, it can reduce the influence of extreme values during the test process and improve the confidence of the test results.

The degree of graphitization C value of the positive electrode film layer can be obtained by a laser microscopic confocal Raman spectrometer in a surface scanning mode. As an example, specifically, a laser microscopic confocal Raman spectrometer (high-precision Renishaw laser microscopic confocal Raman spectrometer) is used, an excitation wavelength of 532 nm is selected, and an appropriate amount of positive electrode film layers is taken to perform surface scanning on its surface or a cross-section along the thickness direction of the electrode plate. A scanning region is 45 μm×45 μm, and divided into 10×10 grids, and with grid vertices as test points, a step size of 5 μm, and a total number of scanning points of 100, C values of different sites and the cumulative distribution curve of the C values in the surface scanning region are obtained. The positive electrode film layer in the present application may be either a freshly prepared positive electrode film layer or a positive electrode film layer obtained by disassembling a battery. The surface of the positive electrode film layer obtained from the battery disassembly inevitably has residual electrolyte salt particles. In order to improve the test accuracy, it is preferred to perform surface scanning on the cross-section of the positive electrode film layer along the thickness direction of the electrode plate to characterize the degree of graphitization of the positive electrode film layer.

The degree of graphitization C value of the positive electrode film layer is obtained by a band intensity ratio of a G-band and a D-band of the Raman spectrum. The G-band position is 1580±100 cm⁻¹, which characterizes a carbon sp² hybrid structure; and the D-band position is 1350±100 cm⁻¹, which characterizes a disordered structure, where disorder means that there is no regular arrangement between carbon atoms in the structure. In graphite crystals, carbon atoms in the same layer form covalent bonds by sp² hybridization, and the interlayers are bound by van der Waals force, which makes the carbon in the graphite structure easy to slip. Therefore, the C value may characterize the degree of graphitization of the positive electrode film layer. It can be understood that the degree of graphitization in the positive electrode film layer mainly comes from the carbon material in the positive electrode film layer that has undergone graphitization treatment, that is, the carbon material layer of the positive electrode active material. Although carbon nanotube conductive agents rich in sp² hybrid structure also have relatively high I_{G}/I_{D}, due to their low added content and small tube diameter, their addition to the positive electrode film layer shows an extreme value in the Raman surface scanning test of the positive electrode film layer, and will not affect the degree of graphitization C₅₀ in the positive electrode film layer. Therefore, the degree of graphitization of the positive electrode film layer can also be used to characterize the degree of graphitization of the positive electrode active material.

Those skilled in the art can adjust the degree of graphitization of the active material particles by any known process. As an example, the degree of graphitization of the active material particles can be adjusted by regulating a carbon source, a sintering temperature, sintering time, a sintering pressure, and a sintering atmosphere.

The higher the degree of graphitization of the carbon on the surface of the positive electrode active material, the higher the proportion of graphite structure carbon in the positive electrode film layer, and the easier it is for the particles to slip with the help of the highly graphitized carbon structure in the coating layer, reducing the stress concentration in the electrode plate.

In some examples, in the cumulative distribution curve of degree of graphitization C value of the positive electrode film layer obtained by the laser microscopic confocal Raman spectrometer in the surface scanning mode, the median C₅₀ of the degree of graphitization is optionally 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20 or any numerical range therebetween.

In the examples of the present application, the median C₅₀ of the degree of graphitization is within the above range, which helps to improve the slippage of the particles in the positive electrode film layer, reduce stress concentration during the compaction of the thick-coated film layer, and reduce the probability of film layer falling-off due to local stress concentration during long cycles of the positive electrode film layer, thereby further alleviating the capacity plummeting problem of the battery cell while improving the volumetric energy density of the battery, and extend the cycle life of the battery.

In some embodiments, in a cumulative distribution curve of coating value B of the positive electrode film layer obtained by a laser microscopic confocal Raman spectrometer in a surface scanning mode, a median B₅₀ of the coating value is 0.30 to 0.60, wherein the coating value B is I_{P}/I_{D}, I_{P} represents the P-band intensity of the Raman spectrum at 948±100 cm⁻¹, and I_{D} represents the D-band intensity of the Raman spectrum at 1350±100 cm⁻¹.

The cumulative distribution curve of coating value B refers to a curve obtained by arranging at least 100 obtained B values in an ascending order, with the coating value as the horizontal axis and a cumulative number proportion as the vertical axis. In order to reduce the influence of extreme coating values caused by a non-particle region in the positive electrode film layer on the test results, the median B₅₀ of the coating value is used to evaluate the compactness of the carbon material layer on the positive electrode active material. B₅₀ is a B value corresponding to a cumulative number proportion of 50% of the vertical axis in the cumulative distribution curve of coating value B.

In the present application, the coating value B of the positive electrode film layer may be obtained by scanning with a laser microscopic confocal Raman spectrometer. As an example, specifically, a laser microscopic confocal Raman spectrometer (high-precision Renishaw laser microscopic confocal Raman spectrometer) is used, an excitation wavelength of 532 nm is selected, and an appropriate amount of positive electrode film layers is taken to perform surface scanning on its surface or a cross-section along the thickness direction of the electrode plate. A scanning region is 45 μm×45 μm, and divided into 10×10 grids, and with grid vertices as test points, a step size of 5 μm, and a total number of scanning points of 100, B values of different sites and the cumulative distribution curve of the B values in the surface scanning region are obtained. The positive electrode film layer in the present application may be either a freshly prepared positive electrode film layer or a positive electrode film layer obtained by disassembling a battery. The surface of the positive electrode film layer obtained from the battery disassembly inevitably has residual electrolyte salt particles. In order to improve the test accuracy, it is preferred to perform surface scanning on the cross-section of the positive electrode film layer along the thickness direction of the electrode plate to characterize the coating value of the positive electrode film layer.

The coating value B of the positive electrode film layer is obtained by a band intensity ratio of a P-band and a D-band of the Raman spectrum. The P-band position is 948±100 cm⁻¹, which characterizes a phosphate PO₄³⁻ structure; and the D-band position is 1350±100 cm⁻¹, which is one of characteristic peaks of the carbon material and characterizes the defects or disordered structures in sp² hybrid carbon atom lattices. During the test, an excitation wavelength of 532 nm is selected and the test depth is shallow. Therefore, in the test results of the positive electrode film layer obtained in the surface scanning mode of the laser microscopic confocal Raman spectrometer, the carbon structure band shows a higher intensity than the phosphate structure band.

Those skilled in the art can adjust the coating value of the active material particles by any known process. As an example, the coating value of the active material particles can be adjusted by regulating a carbon source type, a carbon source adding amount, a sintering temperature, sintering time, a sintering pressure, and a sintering atmosphere. The coating value B can reflect the compactness of the carbon material layers on the surfaces of the lithium-containing transition metal phosphate particles. The denser the carbon material layer, the lower the phosphate structure strength detected in the Raman spectrum, and the smaller the coating value B of the positive electrode film layer.

In some embodiments, the positive electrode film layer further includes a coating layer disposed on at least a portion of the surfaces of the lithium-containing transition metal phosphate particles. In the cumulative distribution curve of coating value B of the positive electrode film layer obtained by the laser microscopic confocal Raman spectrometer in the surface scanning mode, the median B₅₀ of the coating value is optionally 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6 or any numerical range therebetween.

The median B₅₀ of the coating value of the positive electrode film layer being within the above range indicates that the carbon material layer of the positive electrode active material is relatively dense and uniform, which is beneficial to improving the slip uniformity of the positive electrode film layer during rolling and reducing the stress concentration in the thick-coated positive electrode film layer. In addition, with the help of the dense and uniform carbon material layer, the large particles in the positive electrode film layer are easier to slip during the compaction process, thereby reducing the stress concentration at the large particles in the thick-coated positive electrode film layer, reducing the probability of the positive electrode film layer falling off, alleviating the battery capacity plummeting problem, and extending the cycle life of the battery.

In some embodiments, the lithium-containing transition metal phosphate particles in the positive electrode film layer include components represented by the following general formula:

LiₘFeₓP_{y}OⱼQ_{q} Formula I,
where Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

In some embodiments, m is optionally 0.8, 0.85, 0.9, 0.95, 0.98, 1.00, 1.03, 1.05, 1.08, 1.10, 1.13, 1.15, or any numerical range therebetween; x is optionally 0.9, 0.91, 0.92, 0.93, 0.94, 0.95, 0.96, 0.97, 0.98, 0.99, 1.0, or any numerical range therebetween; y is optionally 0.95, 0.96, 0.97, 0.98, 0.99, 1.00 or any numerical range therebetween; j is optionally 3.5, 3.6, 3.7, 3.8, 3.9, 4 or any numerical range therebetween; and q is optionally 0, 0.01, 0.02, 0.03, 0.04, 0.05, 0.06, 0.07, 0.08, 0.09, 0.1 or any numerical range therebetween.

In some embodiments, the lithium-containing transition metal phosphate particles in the positive electrode film layer include one or more of lithium iron phosphate, lithium manganese phosphate, lithium vanadium fluorophosphate, lithium manganese iron phosphate and their modified materials.

In some embodiments, the lithium-containing transition metal phosphate particles in the positive electrode film layer include one or more of lithium iron phosphate and its doping modification materials and coating modification materials.

In some embodiments, an iron dissolution rate of a positive electrode material is 658 ppm to 1921 ppm.

The iron dissolution rate of the positive electrode material can be tested by a method known in the art. As an example, 7.5 g of positive electrode material powder obtained by scraping from a positive electrode film layer sample is weighed and added to 100.3 g of an ascorbic acid solution with a mass concentration of 0.3% (a solvent is ultrapure water). After stirring at 500 revolutions per minute for 305 minutes, the solution is quickly aspirated using a 5 mL syringe, and the solution is filtered into a test tube using a 0.45 μm pore size filter. 1 mL of a supernatant is aspirated with a pipette, added to a glass volumetric flask and diluted 50 times. The solution is tested using an inductively coupled plasma mass spectrometer (ICP-OES) to obtain an iron element concentration in the solution. The iron dissolution rate of the positive electrode material is calculated using a formula: (ICP-tested iron element concentration×solution volume/mass of a participating volumetric solution)×100.3 g/mass of the positive electrode material powder, wherein the solution volume is 50 mL, and the mass of the participating volumetric solution is 1 g.

In some embodiments, the iron dissolution rate of the positive electrode material is optionally 658 ppm, 700 ppm, 800 ppm, 890 ppm, 900 ppm, 1000 ppm, 1058 pm, 1076 pm, 1100 ppm, 1143 pm, 1200 ppm, 1236 pm, 1300 ppm, 1311 pm, 1384 pm, 1349 pm, 1400 ppm, 1485 pm, 1500 ppm, 1531 pm, 1600 ppm, 1700 ppm, 1800 ppm, 1921 ppm or any numerical range therebetween.

In some embodiments, the iron dissolution rate of the positive electrode material is 658 ppm to 1485 ppm.

The iron element dissolved in the positive electrode material mainly comes from the lithium-containing transition metal phosphate particles in the positive electrode active material. The iron dissolution rate depends on the number of lattice defects of the lithium-containing transition metal phosphate on the one hand, and on the integrity and density of the carbon material layer on the surface of the positive electrode active material on the other hand. The lower the iron dissolution rate means that the lithium-containing transition metal phosphate has fewer lattice defects, which is beneficial to reducing the corrosion of the lattice in a weak acid environment; and the more complete and dense the carbon material layer on the surface of the positive electrode active material, the more they inhibit the dissolution of iron ions in a weak acid environment. The positive electrode material with the iron dissolution rate within the above range has relatively few lattice defects and a complete and dense carbon material layer, which is beneficial to improving the compressive resistance and slippage of the particles in the positive electrode film layer under large rolling pressure, increasing the compacted density of the thick-coated positive electrode film layer and reducing stress concentration in the positive electrode film layer, improving the energy density of the battery while taking into account the alleviation of the battery capacity plummeting problem and extending the cycle life of the battery.

In some embodiments, based on the total mass of the lithium-containing transition metal phosphate particles in the positive electrode film layer, the mass content of a titanium element is 500 ppm to 8000 ppm.

In some embodiments, based on the total mass of the lithium-containing transition metal phosphate particles in the positive electrode film layer, the mass content of a titanium element is 1000 ppm to 3000 ppm.

The types and contents of elements in the lithium-containing transition metal phosphate particles in the positive electrode film layer can be tested by any method known in the art. As an example, the titanium element and content are tested using inductively coupled plasma optical emission spectrometry according to Appendix C of GB/T 33822-2017.

In some embodiments, based on the total mass of the lithium-containing transition metal phosphate particles in the positive electrode film layer, a mass content of the titanium element is optionally 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm or any numerical range therebetween.

The introduction of the titanium element into the lithium-containing transition metal phosphate particles requires the addition of a titanium source during the preparation of the positive electrode active material. The titanium source is often inert materials, and adhering to the surface of lithium-containing transition metal phosphate raw materials can reduce reaction activity and reduce particle size growth. Increasing the degree of graphitization of the positive electrode active material often requires a higher sintering temperature or a longer sintering time, but this will also increase the size of the particles in the positive electrode film layer, increase the stress concentration of the positive electrode film layer, and cause the positive electrode film layer to fall off. In the examples of the present application, a high content of titanium elements is added to the lithium-containing transition metal phosphate particles, so that the reactivity of the raw materials for synthesizing the positive electrode active material is reduced, the positive electrode active material can achieve control of the proportion of large particles while having a high degree of graphitization, stress concentration in the positive electrode film layer is reduced, and the probability of film layer falling-off of the positive electrode film layer is reduced, thereby improving the battery energy density while taking into account the cycle life of the battery.

At the same time, the doping of the titanium element in the positive electrode active material is beneficial to cause lattice distortion, reduce Li—O bond energy, increase a lithium ion transmission rate, and improve the kinetic performance of the battery. The lithium ion diffusion in the thick-coated film layer is uneven, often accompanied by a significant lithium ion concentration gradient. The example of the present application improves the solid-phase transmission rate of the positive electrode active material by adding a high content of titanium elements to the lithium-containing transition metal phosphate particles, thereby improving the kinetic problems of thick electrode plate batteries.

In some embodiments, based on the total mass of the lithium-containing transition metal phosphate particles in the positive electrode film layer, the mass content of a vanadium element is 500 ppm to 5000 ppm.

The types and contents of elements in the lithium-containing transition metal phosphate particles in the positive electrode film layer can be tested by any method known in the art. As an example, the vanadium element and content are tested using inductively coupled plasma optical emission spectrometry according to Appendix C of GB/T 33822-2017.

In some embodiments, based on the total mass of the lithium-containing transition metal phosphate particles in the positive electrode film layer, a mass content of the vanadium element is optionally 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm or any numerical range therebetween.

In some embodiments, based on the total mass of the lithium-containing transition metal phosphate particles in the positive electrode film layer, the mass content of a vanadium element is 500 ppm to 3000 ppm.

The vanadium element in the positive electrode film layer may be in multiple valence states. Vanadium with a valence of +5 (V⁵⁺) may be doped at a phosphorus element site. Due to its large radius, it may cause lattice distortion and expand a diffusion channel of lithium ions, thereby improving the ionic conductivity of the positive electrode active material and improving the kinetic performance of the battery. Vanadium with a valence of +3 (V³⁺) may be doped at a transition metal site to generate lithium vacancies through charge compensation, thereby improving the electronic conductivity of the positive electrode active material. In addition, the improved distribution uniformity of the vanadium element in lithium-containing transition metal phosphate particles helps to further improve the kinetic performance and reaction uniformity of the positive electrode film layer, thereby further improving the kinetic performance and cycle performance of the battery cell.

The mass content of the vanadium element in the above range is helpful to improve the kinetic performance of the positive electrode plate and the kinetic performance of the thick-coated lithium-containing transition metal phosphate battery. At the same time, the synergistic effect of the titanium element, the vanadium element and carbon nanotubes in the positive electrode film layer helps to form a good three-dimensional network, further improving the electronic conductivity and ionic conductivity of the positive electrode film layer, thereby further improving the kinetic performance of the thick-coated lithium-containing transition metal phosphate battery.

In some embodiments, the positive electrode film layer further includes a conductive agent, and based on the total area of a cross-section of the positive electrode film layer along the thickness direction of the electrode plate, the area proportion of an agglomeration region of the conductive agent is 0.5% to 2.5%.

In the present application, based on the total area of the cross-section of the positive electrode film layer along the thickness direction of the electrode plate, the area proportion of the agglomeration region of the conductive agent can be tested by the following method. A similar method as described above is used to observe the cross-section of the positive electrode film layer along the thickness direction of the electrode plate through a scanning electron microscope, and the area of the agglomeration region of the conductive agent in the scanning electron microscope image is measured at a magnification of 3 k times. Since the conductive agents are generally carbon-based materials, such as conductive carbon black, carbon nanotubes, etc., aggregated conductive agents can be seen under the high magnification of the scanning electron microscope. The agglomeration region of the conductive agent often appears black agglomerates compared to other regions in the positive electrode film layer. With the help of image analysis software, the agglomeration region of the conductive agent refers to a region in the scanning electron microscope image where the conductive agent is obviously aggregated and appears black. Specifically, the scanning electron microscope image at a magnification of 3 k times is imported into ImageJ, and a black conductive agent agglomeration region with Feret greater than or equal to 2 μm is screened out. The sum of the areas of the screened regions is counted and recorded as the area of the agglomeration region of the conductive agent. The area proportion of the agglomeration region of the conductive agent is a ratio of the area of the agglomeration region of the conductive agent to the total area of the imported scanning electron microscope image. Three non-overlapping scanning electron microscope images are randomly select, and an average value of the area proportion of the agglomeration region of the conductive agent is calculated as “the area proportion of the agglomeration region of the conductive agent based on the total area of the cross-section of the positive electrode film layer along the thickness direction of the electrode plate”.

In some embodiments, the positive electrode film layer further includes a conductive agent, and based on the total area of the cross-section of the positive electrode film layer along the thickness direction of the electrode plate, the area proportion of the agglomeration region of the conductive agent is optionally 0.5%, 0.6%, 0.7%, 0.8%, 0.9%, 1%, 1.1%, 1.2%, 1.3%, 1.4%, 1.5%, 1.6%, 1.68%, 1.7%, 1.8%, 1.9%, 2%, 2.1%, 2.2%, 2.3%, 2.4%, 2.41%, 2.5% or any numerical range therebetween.

Based on the total area of the cross-section of the positive electrode film layer along the thickness direction of the electrode plate, the area proportion of the agglomeration region of the conductive agent is within the above range, indicating that the conductive agent is evenly dispersed in the positive electrode film layer and is easy to form a uniform conductive network, which is particularly beneficial to reducing the problem of kinetic degradation caused by the increase of an ion transmission path in the thick-coated film layer, reducing the local polarization and even lithium plating problems generated by the battery during the cycle process, and improving the cycle life of the battery.

At the same time, studies have shown that large-sized particles in the lithium-containing transition metal phosphate particles are prone to rebound. The agglomeration area of the conductive agent within the above range can suppress the rebound of the lithium-containing transition metal phosphate particles with the help of the uniform distribution of the conductive agent, form mechanical constraints on the particles and even the film layer, improve the cohesion of the film layer, reduce the powder loss and falling-off of the film layer, and improve the cycle life of the battery.

In some embodiments, the positive electrode film layer further includes a conductive agent, and based on the total area of a cross-section of the positive electrode film layer along the thickness direction of the electrode plate, the area proportion of an agglomeration region of the conductive agent is 1.5% to 2.5%.

In the example of the present application, the area proportion of the agglomeration region of the conductive agent is further within the above range, indicating that the conductive agent is more evenly distributed in the positive electrode film layer and the content of the conductive agent is relatively low. While improving the kinetic performance of the positive electrode film layer, it helps to reduce the occupied space of the positive electrode active material due to excessive conductive agents, thereby further improving the volumetric energy density of the battery while improving the battery kinetic performance.

In some embodiments, the conductive agent includes carbon nanotubes, and the carbon nanotubes include one or more of single-walled carbon nanotubes, few-walled carbon nanotubes, and multi-walled carbon nanotubes.

In the present application, the term “carbon nanotube” refers to a nano material having several to dozens of coaxial hollow tubes formed by rolling up graphene sheets formed by sp² hybrid bonding of carbon atoms. The diameter is usually in the range of several to tens of nanometers, and the length may range from micrometers to centimeters, showing a high aspect ratio. According to the number of layers of graphene sheets, they may be divided into single-walled carbon nanotubes (SWCNTs), few-walled carbon nanotubes (FWCNTs) and multi-walled carbon nanotubes (MWCNTs). Carbon nanotubes have excellent conductivity and high elastic modulus.

Since the carbon nanotubes have a one-dimensional structure, they can form a network structure in the positive electrode film layer. On the one hand, the high elastic modulus of the carbon nanotubes enables its network structure to not only serve as a bridge for stress propagation, but also has a binding effect on the thick-coated positive electrode film layer, inhibiting the rebound of the lithium-containing transition metal phosphate particles, effectively alleviating stress concentration, reducing the risk of film layer falling-off, and thus alleviating the problem of battery capacity plummeting; and on the other hand, the excellent conductivity of the carbon nanotubes makes its network structure an efficient electron transmission channel. Even if there is local film layer falling-off, the thick electrode plate can still maintain high electron transmission efficiency in the in-plane direction and thickness direction, thereby delaying the occurrence of the capacity plummeting problem and further improving the battery's dynamic performance and cycle life.

In some embodiments, the conductive agent further includes conductive carbon black.

The conductive carbon black has a high specific surface area and thus has good liquid retention capacity. The thick electrode plate has a large expansion force during the cycle, which makes the electrolyte solution easy to squeeze out. The distribution of the conductive carbon black in the positive electrode film layer is conducive to improving the liquid retention capability of the thick electrode plate, further alleviating the phenomenon of battery capacity plummeting during the cycle, and improving the cycle life of the battery.

In some embodiments, the agglomeration region of the conductive agent includes carbon nanotubes and conductive carbon black.

Researchers found that the carbon nanotubes are prone to agglomeration due to their high surface energy, resulting in uneven dispersion in the positive electrode film layer and the inability to form an effective carbon nanotube network structure. The surface energies of the conductive carbon black and the carbon nanotubes are relatively close, and the conductive carbon black can be adsorbed on the surfaces of the carbon nanotubes to form a physical barrier, thereby increasing the resistance of carbon nanotube agglomeration, reducing direct contact between the carbon nanotubes, and thus inhibiting agglomeration and improving the distribution uniformity of the carbon nanotubes in the positive electrode film layer. On the one hand, this helps to improve the conductivity of the thick-coated positive electrode film layer and improve the dynamic performance of the battery; and on the other hand, it helps to exert the binding effect of the carbon nanotubes on the positive electrode film layer, reduce the risk of falling-off of the thick-coated positive electrode film layer, and further improve the dynamic performance and cycle life of the battery. In addition, the agglomeration of the carbon nanotubes in the conductive agent agglomeration area will also lead to blockage of local ion transmission pathways in the conductive agent agglomeration area. The combination with the conductive carbon black can improve the lithium ion transmission capability in this region, reduce local polarization, and further improve the cycle stability of the battery.

In some embodiments, based on the mass of the positive electrode film layer, the mass content C1 of the carbon nanotubes satisfies: 0<C1≤2.5%, and the mass content C2 of the conductive carbon black satisfies: 0<C2≤2.5%.

In some embodiments, based on the mass of the positive electrode film layer, the mass content C1 of the carbon nanotubes is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or any numerical range therebetween.

In some embodiments, based on the mass of the positive electrode film layer, the mass content C2 of the conductive carbon black is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or any numerical range therebetween.

The mass contents of the carbon nanotubes and the conductive carbon black are within the above ranges, which can effectively alleviate the agglomeration of the carbon nanotubes and form a good conductive network structure, thereby effectively reducing the stress concentration of the positive electrode film layer, improving the liquid retention rate of the positive electrode plate during long cycles, further reducing the risk of electrode plate film layer falling-off and the degree of polarization, improving the battery's kinetic performance while taking into account the capacity plummeting problem and improving the battery's cycle life.

In some embodiments, the positive electrode film layer further includes a dispersant, and the dispersant includes hydrogenated nitrile rubber (HNBR).

HNBR is obtained by hydrogenating and saturating the double bonds of nitrile rubber. Its highly saturated main chain structure gives it excellent oil resistance, heat resistance and aging resistance. This allows it to remain stable in different environments and systems when used as a dispersant, making it less likely to degrade or deteriorate, thereby effectively exerting its dispersing effect. HNBR molecular chains contain both polar nitrile groups and non-polar hydrocarbon segments. The polar nitrile group may interact with some polar substances or particle surfaces, such as being adsorbed on the surfaces of dispersed particles through hydrogen bonds, electrostatic effects, etc.; and the non-polar hydrocarbon segments have good lipophilicity and can stretch and disperse well in non-polar or weakly-polar media, so that the particles are evenly dispersed in the media.

When HNBR is adsorbed on the surfaces of particles in a slurry, its long-chain molecules will form a physical barrier around the particles, preventing the particles from approaching and aggregating with each other, so that the particles remain a relatively independent dispersed state in the systems. At the same time, HNBR may reduce the surface tension between the dispersion medium and the dispersed particles, making the particles easier to wet by the medium, thereby promoting the dispersion of the particles in the medium. At the same time, it can also reduce the interfacial energy between the particles and reduce the aggregation of the particles driven by interfacial energy. Further, when the slurry is dried to form a film, an elastic network structure of HNBR can buffer the shrinkage stress caused by solvent volatilization, reduce the re-aggregation of the conductive agent due to capillary force in this process, reduce the area proportion of the conductive agent agglomeration region, and improve the battery's dynamic performance and cycle life.

In some embodiments, based on the mass of the positive electrode film layer, the mass content of the dispersant is 0.5% to 2%.

In some embodiments, based on the mass of the positive electrode film layer, the mass content of the dispersant is optionally 0.5%, 0.6%, 0.7%, 0.8%, 0.9%, 1%, 1.5%, 2% or any numerical range therebetween.

The mass content of the dispersant is within the above range, which can achieve uniform dispersion of particles in the positive electrode film layer while maintaining a high loading capacity of the positive electrode film layer, reduce stress concentration in the thick-coated lithium-containing transition metal phosphate positive electrode film layer, and effectively alleviate the problem of battery capacity plummeting.

In some embodiments, a porosity of the negative electrode film layer is 14% to 28%.

In the present application, the porosity of the positive electrode film layer can be tested in the following manner. The scanning electron microscope image of the cross-section of the positive electrode film layer along the thickness direction of the electrode plate, obtained as described above, is imported into ImageJ software. The line tool is selected, and the length of the scale in the image is marked with a line. “Analyze Set Scale” is clicked, and the scale parameters in the software are set according to the scale length in the image. The rectangular tool is selected, and the part of the image excluding the scale area is chosen. The selected area is duplicated using “Image Duplicate”, and the image format is adjusted using “Image Type 8 bit”. “Analyze Set Measurements” is selected, and the following 5 options are chosen: “Area”, “Mean gray value”, “Area Fraction”, “Limit to threshold”, and “Feret's diameter”. For “Decimal places”, 3 is selected. Subsequently, “Image”-“Adjust”-“Threshold” is selected in sequence, and values of 0 and 100 are set in turn in the “Threshold” selection box. The pore data in the cross-sectional SEM image can then be exported using the Analyze-Measure function. Export is performed using “Image”-“Overlay”-“Flatten” to obtain the pore image. “Apply” in “Threshold” is clicked, followed by “Analyze”-“Analyze Particles”. By checking the first four columns on the left, the statistical data of pores can be obtained.

It can be understood that in the example of the present application, the “pores” in the cross-section of the positive electrode film layer are recognized by using image color differences and thresholds. This “pore” is not the pore data obtained in the exhaust test, but is mainly used to characterize the gap between particles in the cross-section of the positive electrode film layer. This method is superior to the exhaust method because the porosity obtained by the exhaust method is related to the pores between the particles and the pores in the carbon material layer on the surfaces of the particles, and cannot objectively reflect the pores between the particles.

In some embodiments, the porosity of the positive electrode film layer is optionally 14%, 15%, 16%, 17%, 18%, 19%, 20%, 21%, 22%, 23%, 24%, 25%, 26%, 27%, 28% or any numerical range therebetween.

The porosity of the positive electrode film layer is within the above range, and the positive electrode film layer has good electrolyte solution infiltration rate and tortuosity, which is conducive to the diffusion of lithium ions in liquid and solid phases, helps to reduce the concentration polarization of thick electrode plates, and improves the dynamic performance of the battery. At the same time, it helps to alleviate the volume expansion of thick-coated electrode plates during the cycle, reduce the mechanical stress of the film layer and reduce stress concentration, thereby reducing the risk of film layer falling-off of the thick-coated electrode plates.

Especially in thick-coated soft-pack batteries, a gap between a shell and an electrode plate is small, the volume occupancy of the film layer is large, the electrolyte solution holding volume is reduced, and the porosity of the positive electrode film layer is within the above range, which helps to improve the liquid retention rate of the battery cell and improve the battery's dynamic performance.

In some embodiments, the battery cell also includes a separator 20 arranged between the positive electrode plate and the negative electrode plate, the separator 20 includes a base membrane 201, a ceramic layer 202 arranged on at least one side of the base membrane 201 and an adhesive layer 203 arranged on the side of the ceramic layer 202 away from the base membrane 201, the adhesive layer 203 is a continuous layer with a porous structure, and the adhesive layer 203 includes a vinylidene fluoride polymer.

In some embodiments, the battery cell also includes a separator arranged between the positive electrode plate and the negative electrode plate, the separator includes a base membrane, ceramic layers arranged on two sides of the base membrane and an adhesive layer arranged on the side of the ceramic layer located on at least one side away from the base membrane.

The ceramic layers arranged on both sides of the base membrane are beneficial to improving the rigidity of the soft-pack battery and reducing local stress concentration.

In some embodiments, the battery cell also includes a separator arranged between the positive electrode plate and the negative electrode plate, the separator includes a base membrane, ceramic layers arranged on two sides of the base membrane and adhesive layers arranged on the sides of the ceramic layers located on two sides away from the base membrane.

In some embodiments, the vinylidene fluoride polymer includes one or more of polyvinylidene fluoride (PVDF) and polyvinylidene fluoride-hexafluoropropylene copolymer (PVDF-HFP).

In some embodiments, the vinylidene fluoride polymer includes polyvinylidene fluoride (PVDF).

In the prior art, an adhesive layer of a separator usually uses water-based PVDF, which presents an island-like structure in the separator, as shown in FIG. 2. On the one hand, this is conducive to providing gaps for the expansion of a cell, and on the other hand, it is easy to manufacture; however, the contact area between the adhesive layer of such a separator and an electrode plate is small, and the bonding force is weak.

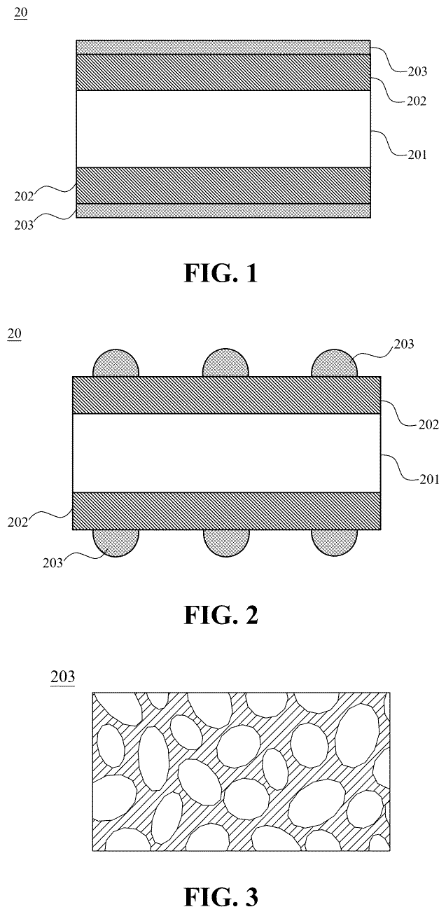

The separator provided in the example of the present application uses the continuous layer with the porous structure as the adhesive layer, as shown in FIG. 1 and FIG. 3. Compared with the adhesive layer in the prior art, its bonding area with the electrode plate is larger, thereby making the bonding between the separator and the electrode plate more firm and uniform. Further, when the positive electrode film layer rebounds, it is beneficial to maintain the interface contact between the separator and the positive electrode film layer, thereby reducing the probability of film layer falling off.

It is understandable that the continuous adhesive layer may break and deform into a block structure due to contact or extrusion with the positive electrode plate or the negative electrode plate during the manufacturing or cycle process of the electrode plates. The continuous structure referred to in the present application means that at the microscopic level, such as when observed under a scanning electron microscope or an optical microscope, the adhesive layer of the separator is continuous. In order to reflect the true form of the separator, during the sampling process, it is preferred to sample a region where the adhesive layer of the separator in the battery is not bonded to the positive electrode plate or the negative electrode plate. As an example, sampling is performed at a position of the separator beyond the positive electrode plate and the negative electrode plate; or sampling is performed at a separator close to the surface of the electrode assembly. The separator sampling region has less adhesion with the positive electrode plate or the negative electrode plate, and can better reflect the real state of the separator.

Compared with wound battery cells, the extrusion between the separator and the electrode plate in a stacked electrode assembly is smaller, and the separator and the electrode plate are prone to relative displacement, which disturbs the film layer and makes the film layer prone to powder loss or falling off; in addition, it may also cause the positive and negative electrodes to overlap with each other, increasing the risk of internal short circuit in the battery cell. Therefore, the separator provided in the examples of the present application is particularly suitable for the stacked electrode assembly. The increased bonding force between the porous adhesive layer and the electrode plate helps to improve the bonding force between the separator and the electrode plate and reduce the relative displacement between the separator and the electrode plate. This helps to reduce the disturbance to the positive electrode film layer and the probability of film layer falling off, and also helps to reduce the risk of short circuit of the battery cell caused by overlapping of the positive and negative electrodes.

In summary, when the vinylidene fluoride polymer in the adhesive layer of the example of the present application is selected from the above materials, it helps to form the continuous and uniform porous adhesive layer. First, the bonding force between the adhesive layer and the electrode plate is improved and evenly distributed, which helps to reduce stress concentration in thick-coated lithium-containing transition metal phosphate positive electrode film layers and reduce the risk of film layer falling-off, thereby helping to further improve the cycle life of the battery; secondly, the adhesive layer is stably bonded to the positive electrode plate or the negative electrode plate, which helps to reduce the direct contact between the positive electrode plate and the negative electrode plate due to the relative displacement of the electrode plate and the separator, reduces the risk of internal short circuit, and helps to improve the safety performance of the battery; and thirdly, the porous adhesive layer helps to maintain the porosity of the separator, reserves space for the expansion of the battery cell, and further improves the cycle life of the battery.

In some embodiments, the materials of the basement membrane may include, but are not limited to, one or more of glass fiber, non-woven fabric, polyethylene (PE), and polypropylene (PP).

In some embodiments, the ceramic layer includes one or more of aluminum oxide (Al₂O₃), zirconium oxide (ZrO₂), titanium oxide (TiO₂), silicon oxide (SiO₂), and boron nitride (BN).

Ceramic particles are flame retardant and have a high hardness value. They are not easily deformed by heat and therefore have excellent dimensional stability. The low thermal conductivity of ceramic materials can further prevent certain thermal runaway points in the battery from expanding into overall thermal runaway, thereby improving the safety performance of the battery cell.

In some embodiments, the thickness of the base membrane in the separator is 7-9 μm.

In some embodiments, the thickness of the base membrane in the separator is optionally 7 μm, 7.5 μm, 8 μm, 8.5 μm, 9 μm, or any numerical range therebetween.

In some embodiments, the single-side thickness of the ceramic layer in the separator is 2-4 μm.

In some embodiments, the single-side thickness of the ceramic layer in the separator is optionally 2 μm, 2.5 μm, 3 μm, 3.5 μm, 4 μm or any numerical range therebetween.

In some embodiments, the single-side thickness of the adhesive layer in the separator is 1-5 μm.

In some embodiments, the single-side thickness of the adhesive layer in the separator is optionally 1 μm, 1.5 μm, 2 μm, 2.5 μm, 3 μm, 3.5 μm, 4 μm, 4.5 μm, 5 μm or any numerical range therebetween.

If the thickness of the adhesive layer is too low, the gap space in the separator is small, and the bonding force between the separator and the electrode plate is low. On the one hand, the stress increases after the film layer expands and the probability of film layer falling-off increases, affecting the cycle life of the battery; and on the other hand, the probability of positive and negative electrode short circuit increases, thereby affecting the safety performance of the battery. If the thickness of the adhesive layer is too large, a space utilization rate on the battery is high, thereby affecting the volumetric energy density of the battery. In the examples of the present application, the thickness of the adhesive layer is within the above range, which helps to take into account the cycle life, safety performance and volumetric energy density of the battery.

In some embodiments, the positive electrode film layer is provided with a primer layer in the bottom region near the positive electrode current collector. The primer layer includes a conductive agent and a binder. The conductive agent includes carbon nanotubes and conductive carbon black. The binder includes a vinylidene fluoride polymer.

In some embodiments, the thickness of the primer layer is 0.5 μm to 5 μm.

In some embodiments, the thickness of the primer layer is optionally 0.5 μm, 1 μm, 1.5 μm, 2 μm, 2.5 μm, 3 μm, 3.5 μm, 4 μm, 4.5 μm, 5 μm, or any numerical range therebetween.

The primer layer provided in the example of the present application helps to improve the bonding force between the positive electrode film layer and the positive electrode current collector and alleviate the stress concentration at large particles, thereby reducing the probability of falling-off of the positive electrode film layer and improving the cycle stability of the battery. At the same time, compared with the direct contact between the positive electrode current collector and the positive electrode film layer, the contact area between the primer layer and the positive electrode film layer is increased, which helps to increase the area of electron transmission between the current collector and the positive electrode film layer, thereby reducing the internal resistance of the electrode plate and improving the dynamic performance of the battery.

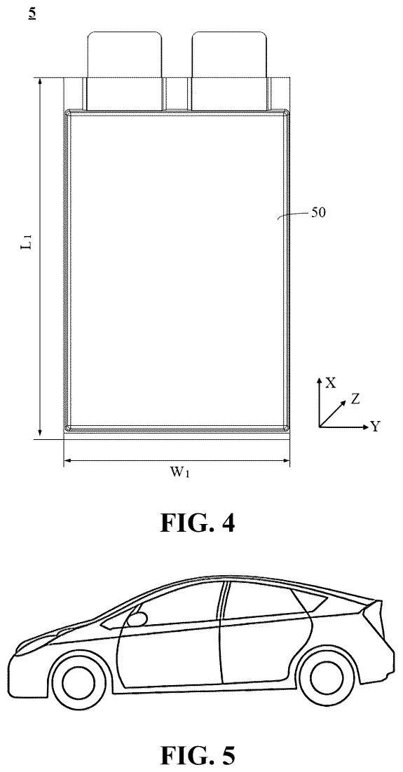

In some embodiments, as shown in FIG. 4, the battery cell 5 includes a shell 50, and a stacked electrode assembly is accommodated in the shell 50. A dimension of the shell 50 in a length direction X is L₁, a dimension of the shell 50 in a width direction Y is W₁, and a dimension of the shell 50 in a thickness direction Z is H₁, wherein 450 mm≤L₁≤1300 mm, 100 mm≤W₁≤150 mm, and 14 mm≤H₁≤22 mm.

In some embodiments, L₁ is optionally 450 mm, 460 mm, 470 mm, 480 mm, 490 mm, 500 mm, 510 mm, 520 mm, 530 mm, 540 mm, 550 mm, 560 mm, 570 mm, 580 mm, 590 mm, 600 mm, 610 mm, 620 mm, 630 mm, 640 mm, 650 mm, 660 mm, 670 mm, 680 mm, 690 mm, 700 mm, 710 mm, 720 mm, 750 mm, 800 mm, 850 mm, 900 mm, 950 mm, 1000 mm, 1050 mm, 1100 mm, 1150 mm, 1200 mm, 1250 mm, 1300 mm or any numerical range therebetween.

In some embodiments, W₁ is optionally 100 mm, 110 mm, 120 mm, 130 mm, 140 mm, 150 mm, or any numerical range therebetween.

In some embodiments, H₁ is optionally 14 mm, 15 mm, 16 mm, 17 mm, 18 mm, 19 mm, 20 mm, 21 mm, 22 mm, or any numerical range therebetween.

In some embodiments, the dimension of the shell in the length direction is L₁, wherein 450 mm≤L₁≤650 mm.

When the dimension L₁ of the shell in the length direction satisfies 450 mm≤L₁≤650 mm, the length of the battery cell is shorter, which helps to shorten a current diffusion path and reduce the internal resistance of the electrode plate, thereby reducing the heat generation of the battery and improving its dynamic performance; in addition, the shorter shell length helps to shorten a diffusion path of the electrolyte solution during the infiltration process, improve the infiltration rate and uniformity of the electrolyte solution, further promote the uniformity of lithium ion insertion and extraction during the cycle, alleviate stress concentration, reduce the risk of film layer falling-off, and improve the cycle stability of the battery cell.

In some embodiments, the dimension of the shell in the length direction is L₁, wherein 900 mm≤L₁≤1300 mm.

When the dimension L₁ of the shell in the length direction satisfies 900 mm≤L₁≤1300 mm, the size of the battery cell is longer, which helps to reduce the volume ratio of the shell in the battery cell and increase the load ratio of the active material. At the same time, longer battery cells can reduce the number of batteries required in a battery module, simplify the structural design of the battery module, and reduce the number and complexity of structural parts in the module, thereby improving the space utilization of a battery pack, and further helping to improve the volumetric energy density of the battery cells.

In some embodiments, as shown in FIG. 4, the material of the shell 50 is a soft pack material, and the soft pack material includes an aluminum-plastic composite film.

In some embodiments, the material of the shell includes a composite film formed by aluminum and one or more of polypropylene (PP), polybutylene terephthalate (PBT), polybutylene succinate (PBS), nylon, polyethylene terephthalate (PET), and polyethylene (PE).

The soft-pack material has a high elongation, so its shell is thinner and softer, which helps to improve the space utilization of the battery cell and thus increase the energy density of the battery cell. In addition, the high barrier properties of aluminum can effectively reduce the penetration of water and oxygen into the battery, reduce the decomposition of the electrolyte solution and the oxidation degree of the electrode material, thereby increasing the battery life.

In some embodiments, at 25 °C, the capacity of the battery cell is 105 Ah to 300 Ah.

In some embodiments, at 25 °C, the capacity of the battery cell is 150 Ah to 190 Ah.

In the present application, the capacity of the battery cell has a meaning well-known in the art, and can be tested by methods known in the art. As an example, the battery is charged to 3.65V at a 0.5 C charge rate, then charged to 0.05 C at a constant voltage of 3.65V, left to stand for 10 minutes, and then discharged to 2.5V at a 1 C discharge rate. The discharge capacity of the battery cell is used as the capacity of the battery cell.

In some embodiments, at 25 °C, the capacity of the battery cell is optionally 105 Ah, 107 Ah, 110 Ah, 115 Ah, 120 Ah, 125 Ah, 130 Ah, 135 Ah, 140 Ah, 145 Ah, 150 Ah, 155 Ah, 160 Ah, 161 Ah, 162 Ah, 163 Ah, 164 Ah, 165 Ah, 170 Ah, 175 Ah, 180 Ah, 182 Ah, 185 Ah, 190 Ah, 200 Ah, 210 Ah, 220 Ah, 230 Ah, 240 Ah, 250 Ah, 270 Ah, 280 Ah, 290 Ah, 300 Ah or any numerical range therebetween.

A second aspect of the present application provides a battery apparatus, including the battery cell provided in the first aspect of the present application.

The battery apparatus disclosed in the example of the present application may be used in an electrical device in which the battery apparatus is used as a power source or in various energy storage systems in which the battery apparatus is used as an energy storage element. The battery apparatus may be used in a vehicle, and may further be used in, but not limited to, a mobile phone, a tablet computer, a laptop, an electric toy, an electric tool, a battery vehicle, an electric vehicle, a ship, a spacecraft, etc. The electric toy may include a fixed or mobile electric toy, such as a game console, an electric vehicle toy, an electric ship toy, an electric airplane toy, and the like. The spacecraft may include an airplane, a rocket, a space shuttle, a spaceship, and the like.

A third aspect of the present application provides an electrical apparatus using a battery apparatus as a power source, and the electrical apparatus includes at least one of a battery cell, a battery module, or a battery pack provided by the present application. The battery cell, the battery module or the battery pack may be used as the power source of the electrical apparatus, and may also be used as an energy storage unit of the electrical apparatus. As the electrical apparatus, the battery cell, the battery module or the battery pack may be selected according to the use requirements thereof.

FIG. 5 is an electrical apparatus as an example. The electrical apparatus disclosed in the example of the present application may be a fuel vehicle, a gas vehicle, or a new energy vehicle, and the new energy vehicle may be an all-electric vehicle, a hybrid vehicle, or an extended-range electric vehicle. The interior of the vehicle is provided with the battery apparatus, and the battery apparatus may be provided at the bottom or head or tail of the vehicle. The battery apparatus may be used to power the vehicle. For example, the battery apparatus may be used as an operating power source of the vehicle. The vehicle may further include a controller and a motor. The controller is used to control the battery apparatus to power the motor. For example, the controller is used for meeting the operating power demand when the vehicle is starting, navigating and driving. In some examples of the present application, the battery apparatus can not only serve as an operating power source of the vehicle, but also may serve as a driving power source of the vehicle, thus replacing or partially replacing fuel or natural gas to provide driving power for the vehicle.

A fourth aspect of the present application provides an energy storage apparatus that uses a battery apparatus as a power source. The energy storage apparatus may be, but is not limited to, an energy storage container, an energy storage cabinet, an energy storage power station, an energy storage battery pack, or a portable energy storage system.

### EXAMPLES

Examples of the present application will be described below. The Examples described below are illustrative and only used to explain the present application, and cannot be construed as limiting the present application. In Examples in which no specific technologies or conditions are specified, technologies or conditions described in the literature in the art or product specifications are followed. The reagents or instruments used without manufacturer indicated are all commercially available conventional products.

### Example 1

### (1) Preparation of Positive Electrode Active Material

Lithium carbonate, iron phosphate, titanium dioxide, vanadium pentoxide, sucrose, glucose, and polyethylene glycol were added to deionized water and mixed in a premixing tank. A ratio of the lithium carbonate to the iron phosphate enabled a molar ratio of lithium to iron to be 1.025:1.0. Based on the total mass of the mixed raw materials, a mass content of the sucrose was 2%, a mass content of the glucose was 4%, and a mass content of the polyethylene glycol was 5%. After even mixing, a mixed raw material with a solid content of 38% was obtained.

A particle size D_{V50} of the lithium carbonate was 6 μm; the morphology of iron phosphate particles was spheroidal; both the titanium dioxide and the vanadium pentoxide were nanoparticles; the purity of the sucrose was ≥98%; a moisture mass content of the glucose was <0.5%; and a weight-average molecular weight of the polyethylene glycol was 1500.

The mixed raw material was subjected to grinding twice in a sand mill. After 1-hour coarse grinding, fine grinding was further performed on the coarsely ground material. During the grinding process, a temperature of a slurry was controlled to be less than 40 °C, and a mixed slurry was obtained. The particle size D_{V50} of solid particles in the mixed slurry was 0.45 μm. Spray drying was carried out to obtain dried precursor powder, and the particle size D₅₀ of the powder after drying was 55.55 μm.

The precursor powder was subjected to two-stage heating sintering in a nitrogen atmosphere to obtain a positive electrode active material: a temperature was raised from 25 °C to 450 °C at a heating rate of 2 °C/min (a first heating stage) and then held for 3 hours; and a temperature was raised from 450 °C to 780 °C at a heating rate of 5 °C/min (a second heating stage) and held for 12 hours. A gas flow rate during the heating stages was higher than that during a constant temperature stage, with a ratio of 1.5:1, and a total gas flow rate was 1350 cm³/h. At the end, the temperature was reduced. A lithium iron phosphate positive electrode active material with a carbon material on its surface and a particle size D_{V50} of 1.65 μm was obtained through jet milling. Based on the total mass of the positive electrode active material, a mass content of a Ti element was 1050 ppm, and a mass content of a V element was 950 ppm.

The above D₅₀, D_{V50} and D_{V90} referred to data obtained by a Malvern laser scattering method.

### (2) Preparation of Positive Electrode Plate

The aforementioned positive electrode active material, conductive agent, and binder polyvinylidene fluoride were mixed with a mass ratio of 95:2:3 in a solvent N-methylpyrrolidone. They were fully mixed and stirred in a stirring tank, and after dispersion, a positive electrode slurry was prepared. After the stirring process was completed, the positive electrode slurry was transported to a coating process. The conductive agent included conductive carbon black and multi-walled carbon nanotubes with a mass ratio of 1:1. A specific surface area of the conductive carbon black was 80 m²/g, and its oil absorption value was 180 mL/100 g. An average length of the carbon nanotubes was 20 μm, and their specific surface area was 280 m²/g.

The positive electrode slurry was transfer-coated onto an aluminum foil, dried, and hot-pressed to obtain a positive electrode plate with a single-side surface density of a positive electrode film layer of 0.38 g/1540.25 mm² and a compacted density of 2.35 g/cm³. The compacted density here referred to the compacted density of the battery cell when it was fully discharged. A transfer-coating speed was 20 m/min. A hot pressing process included three hot roller pressing processes. The hot roller pressing pressure increased successively, and the hot roller pressure was 40 tons, 60 tons, and 80 tons respectively; and a hot roller temperature was 60 °C. Before entering hot roller compaction for the first time, an electrode plate was heated at a heating temperature of 40 °C.

The positive electrode plate was striped and punched into specified shapes, and the punched positive electrode plates were sorted by weight using a weighing sorting machine for being laminated by a laminating machine.

In a cross-section of the positive electrode film layer along a thickness direction of the electrode plate, in a cumulative distribution curve of sphericity area of particles having a particle size R1 satisfying R1≥1000 nm, a median sphericity L_{R1A50} was 0.689; a median C₅₀ of a degree of graphitization of the positive electrode film layer was 1.009; a median B₅₀ of a coating value B of the positive electrode film layer was 0.46; an iron dissolution rate of a positive electrode material was 974 ppm; based on a total area of the cross-section of the positive electrode film layer along the thickness direction of the electrode plate, an area proportion of an agglomeration region of the conductive agent was 1.68%; and a porosity of the positive electrode film layer was 16.03%.

### (3) Preparation of Negative Electrode Plate

A mixture of artificial graphite and natural graphite (with a mass ratio of 1:1), a conductive agent conductive carbon black, a binder styrene-butadiene rubber (SBR), and a thickener sodium carboxymethyl cellulose (CMC) were mixed uniformly with a weight percentage of 96:0.5:2.0:1.5. Deionized water was added. After stirring and dispersion, a negative electrode slurry was obtained. The negative electrode slurry was coated on a substrate copper foil, and after drying, compaction, slitting, and plate manufacturing, a negative electrode plate was obtained.

The negative electrode plate was striped and punched into specified shapes, and the punched negative electrode plates were sorted by weight using a weighing sorting machine for being laminated by a laminating machine.

### (4) Separator

Polyvinylidene fluoride (PVDF) was dissolved in N-methylpyrrolidone (NMP), and stirred evenly, and then polyethylene glycol (PEG) was added as a pore-forming agent, and stirred and mixed thoroughly to obtain an adhesive layer solution. The adhesive layer solution was applied to the above base membrane having ceramic layers on both sides, pre-volatilized at 80 °C and dried at 110 °C, and then immersed in deionized water to dissolve out PEG, thereby obtaining a separator having an adhesive layer with a porous structure.

A thickness of the base membrane was 8 μm, a thickness of the ceramic layer on a single side was 3 μm, and a thickness of the adhesive layer on a single side was 1 μm.

### (5) Electrolyte Solution

In a glove box in an argon atmosphere (H₂O<0.1 ppm, O₂<0.1 ppm), organic solvents ethylene carbonate (EC), dimethyl carbonate (DMC), and ethyl methyl carbonate (EMC) were uniformly mixed.

Lithium hexafluorophosphate was then added and dissolved in the organic solvents to make a concentration of lithium hexafluorophosphate in an electrolyte solution 1.05 mol/L. Vinylene carbonate (VC) was added and stirred uniformly to obtain the electrolyte solution in Example 1.

Based on the total mass of the electrolyte solution, a mass content of the dimethyl carbonate was 26%, a mass content of the ethyl methyl carbonate was 43.3%, a mass content of the ethylene carbonate was 17.3%, and a mass content of the vinylene carbonate was 0.9%.

### (6) Preparation of Battery

The positive electrode plate, the separator and the negative electrode plate were laminated in sequence by using a laminating machine, and the separator played a role of isolating positive and negative electrodes, so that a stacked electrode assembly was obtained. The stacked electrode assembly was glued to wrap a battery cell tightly. The glued stacked electrode assembly was placed in an outer package, which was a soft-pack material aluminum-plastic film. The aluminum-plastic film was formed by combining an inner layer of polypropylene, a middle layer of aluminum foil, and an outer layer of nylon. The aluminum-plastic film outer package was punched and formed by a forming machine and trimmed to obtain a target shape and size. The aluminum-plastic film was then heat-sealed to ensure that packaging tension of the aluminum-plastic film was ≥25 N/8 mm. The battery was vacuum baked and allowed to stand, the electrolyte solution was injected using a flat-head needle, and the battery was packaged. The soft-pack battery was then hot pressed at 45 °C for 2 minutes at a pressure of 90 kg/cm², and cold pressed at 25 °C for 2 minutes at a pressure of 90 kg/cm². Finally, after processes such as formation, vacuum exhaust, and trimming, a battery cell was obtained. A dimension of the battery cell in a length direction was 600 mm, a dimension in a width direction was 125 mm, and a dimension in a thickness direction was 20 mm.

Preparation methods in Examples 2-5 were basically the same as that in Example 1, with the difference that a preparation method of a positive electrode active material was adjusted.

### Example 2

### (2) Preparation of Positive Electrode Active Material

Lithium dihydrogen phosphate, ferrous oxalate, polyethylene glycol with a weight-average molecular weight of 1000, polyethylene glycol with a weight-average molecular weight of 1600, titanium dioxide, and vanadium pentoxide were mixed uniformly in methanol and ground to obtain a mixed raw material. A ratio of the lithium dihydrogen phosphate to the ferrous oxalate enabled a molar ratio of lithium to iron to be 1.025:1.0. The particle size D10 of the ferrous oxalate was 6.5 μm, the particle size D50 was 62 μm, and the particle size D90 was 108 μm. A mass content of an Fe element in the ferrous oxalate was 30.5%, and a mass content of a trivalent iron element was 0.03%.

The mixed raw material was subjected to multiple ball milling steps in a ball mill and demagnetized to obtain a mixed slurry. The number and duration of grinding were controlled, and the particle size D_{V}50 of the ground mixed slurry was 3.15 μm.

The mixed slurry was spray-dried to obtain dried precursor powder, which had a light yellow and uniform appearance.

The precursor powder was placed in a sintering furnace. Under a nitrogen atmosphere, it was heated from 25 °C to 360 °C at a rate of 2 °C/min and held at this temperature for 3.5 hours. Then, it was heated to the second temperature of 780 °C at a rate of 5 °C/min and held at this temperature for 10 hours. After the process was completed, it was cooled down. Based on the total mass of the positive electrode active material, the mass content of a Ti element was 1050 ppm, and a mass content of a vanadium element was 950 ppm.

The obtained material was crushed using a jet milling method with a classification frequency of 21 Hz and a crushing air pressure of 0.54 MPa to obtain a lithium iron phosphate positive electrode active material with a carbon material on its surface.

The above D10, D50, D90 and Dv50 referred to data obtained by a Malvern laser scattering method.

### (2) Preparation of Positive Electrode Plate

The aforementioned positive electrode active material, conductive agent, and binder polyvinylidene fluoride were mixed with a mass ratio of 95:2:3 in a solvent N-methylpyrrolidone. They were fully mixed and stirred in a stirring tank, and after dispersion, a positive electrode slurry was prepared. After the stirring process was completed, the positive electrode slurry was transported to a coating process. The stirring included pre-stirring and main stirring, with a stirring speed of pre-stirring being lower than that of main stirring. A revolution speed of pre-stirring was 25 rpm, a rotation speed was 500 rpm, and pre-stirring time was 15 minutes. The conductive agent included conductive carbon black and multi-walled carbon nanotubes with a mass ratio of 1:1. A specific surface area of the conductive carbon black was 80 m²/g, and its oil absorption value was 180 mL/100 g. An average length of the carbon nanotubes was 20 μm, and their specific surface area was 280 m²/g.

The positive electrode slurry was transfer-coated onto an aluminum foil, dried, and hot-pressed to obtain a positive electrode plate with a single-side surface density of a positive electrode film layer of 0.38 g/1540.25 mm² and a compacted density of 2.35 g/cm³. The compacted density here referred to the compacted density of the battery cell when it was fully discharged.

A hot pressing process included three hot roller pressing processes. The hot roller pressing pressure increased successively, and the hot roller pressure was 35 tons, 55 tons, and 75 tons respectively; and a hot roller temperature was 65 °C. Before entering hot roller compaction for the first time, an electrode plate was heated at a heating temperature of 50 °C.

The positive electrode plate was striped and punched into specified shapes, and the punched positive electrode plates were sorted by weight using a weighing sorting machine for being laminated by a laminating machine.

### Example 3

### (3) Preparation of Positive Electrode Active Material

Lithium carbonate, iron phosphate, sucrose, glucose, titanium dioxide, and vanadium pentoxide were added to water and mixed in a premixing tank at a rotation speed of 1800 rpm. A ratio of the lithium carbonate to the iron phosphate enabled a molar ratio of iron to phosphorus to be 0.97, a mass content of the glucose relative to the iron phosphate was 3.8%, and a mass content of the sucrose relative to the iron phosphate was 1.9%.

The mixed raw material was subjected to two grinding steps in a sand mill. The first grinding was carried out under the conditions of using zirconia balls with a diameter of 0.6 mm and a rotation speed of 500 rpm, with a grinding duration of 1 hour and the pressure in the grinding chamber being less than 0.3 MPa. Then, second grinding was performed to obtain a mixed slurry, with the particle size D_{V}50 of the mixed slurry being 0.435 μm.

The mixed slurry was subjected to spray drying to obtain precursor powder.

The precursor powder was sintered to obtain a lithium iron phosphate cathode material. The sintering process included:

First sintering: the precursor powder was sintered in a nitrogen atmosphere, heated from 25 °C to 765 °C at a heating rate of 5 °C/min, and held at this temperature for 10 hours. After cooling, a first sintered product was obtained.

Grinding and mixing: to the first sintered product were added sucrose accounting for 0.5% of the total mass of the first sintered product, glucose accounting for 1% of the total mass of the first sintered product, and polyethylene glycol accounting for 3.0% of the total mass of the first sintered product. The mixture was divided into two groups for grinding (third grinding). For the first group, grinding was stopped when the D_{V50} of the particles reached 1.02 μm (grinding conditions: 550 rpm, grinding time of 1 hour), obtaining a first group of ground products. For the second group, grinding was stopped when the D_{V50} of the particles reached 0.42 μm (grinding conditions: 500 rpm, grinding time of 4 hours), obtaining a second group of ground products. The first group of ground products and the second group of ground products were mixed in a mass ratio of 70:30 to obtain a mixed intermediate product, which was then subjected to spray drying.

Second sintering: the dried mixed intermediate product was sintered in a nitrogen atmosphere, heated from 25 °C to 800 °C at a heating rate of 5 °C/min, and held at this temperature for 10 hours. After cooling, a second sintered product was obtained.

After the completion of sintering, the product was cooled to below 100 °C, and the second sintered product was crushed using a jet milling method to obtain a lithium iron phosphate cathode active material with a carbon material on its surface. The classification frequency of the jet milling was 23 Hz, and the crushing air pressure was 0.55 MPa. Based on the total mass of the positive electrode active material, the mass content of a Ti element was 1050 ppm, and a mass content of a V element was 950 ppm.

### (2) Preparation of Positive Electrode Plate

The aforementioned positive electrode active material, conductive agent, and binder polyvinylidene fluoride were mixed with a mass ratio of 95:2:3 in a solvent N-methylpyrrolidone. They were fully mixed and stirred in a stirring tank, and after dispersion, a positive electrode slurry was prepared. After the stirring process was completed, the positive electrode slurry was transported to a coating process. The stirring included pre-stirring and main stirring, with a stirring speed of pre-stirring being lower than that of main stirring. A revolution speed of pre-stirring was 25 rpm, a rotation speed was 500 rpm, and pre-stirring time was 15 minutes. The conductive agent included conductive carbon black and multi-walled carbon nanotubes with a mass ratio of 1:1. A specific surface area of the conductive carbon black was 80 m²/g, and its oil absorption value was 180 mL/100 g. An average length of the carbon nanotubes was 20 μm, and their specific surface area was 280 m²/g.

The positive electrode slurry was transfer-coated onto an aluminum foil, dried, and hot-pressed to obtain a positive electrode plate with a single-side surface density of a positive electrode film layer of 0.39 g/1540.25 mm² and a compacted density of 2.36 g/cm³. The compacted density here referred to the compacted density of the battery cell when it was fully discharged. The drying temperature was 95 °C and a speed was 2.0 m/min.

A hot pressing process included three hot roller pressing processes. The hot roller pressing pressure increased successively, and the hot roller pressure was 35 tons, 55 tons, and 75 tons respectively; and a hot roller temperature was 65 °C. Before entering hot roller compaction for the first time, an electrode plate was heated at a heating temperature of 50 °C.

The positive electrode plate was striped and punched into specified shapes, and the punched positive electrode plates were sorted by weight using a weighing sorting machine for being laminated by a laminating machine.

### Example 4

A preparation method of a positive electrode active material in Example 4 was basically the same as that in Example 1, with the difference that there were slight differences in the preparation process of the positive electrode active material. The specific differences included:
(4) Carbon sources in the mixed raw material were sucrose and glucose, where the mass of the sucrose was 2 wt % relative to the mass of the iron phosphate, and the mass of the glucose was 5.7 wt % relative to the mass of the iron phosphate.
(5) The heating and sintering process was different. The precursor powder was sintered at least twice in a nitrogen atmosphere. The first sintering was carried out at 750 °C with a holding time of 8 hours to obtain a primary sintered product.

To the primary sintered product were added 1.5 wt % glucose (based on the mass of the primary sintered product), 3.0 wt % polyethylene glycol (based on the mass of the primary sintered product), titanium dioxide, and vanadium pentoxide. After being ground uniformly, the mixture was divided into two groups for secondary grinding. The grinding parameters of the two groups were different, with the D_{V50} of the particles after grinding controlled to be 2.0 μm for the first group and D_{V50} to be 0.35 μm for the second group. The ground particles of the first group and the second group were mixed in a mass ratio of 30:70, then spray-dried and subjected to the second sintering. The second sintering was conducted at 800 °C with a holding time of 10 hours.

Based on the total mass of the positive electrode active material, a mass ratio of a titanium element was 1050 ppm, and a mass content of a vanadium element was 950 ppm.

(3) The positive electrode slurry was transfer-coated onto an aluminum foil, dried, and hot-pressed to obtain a positive electrode plate with a single-side surface density of a positive electrode film layer of 0.39 g/1540.25 mm² and a compacted density of 2.36 g/cm³. The compacted density here referred to the compacted density of the battery cell when it was fully discharged. The drying temperature was 95 °C and a speed was 2.0 m/min.

A hot pressing process included three hot roller pressing processes. The hot roller pressing pressure increased successively, and the hot roller pressure was 35 tons, 55 tons, and 70 tons respectively; and a hot roller temperature was 65 °C. Before entering hot roller compaction for the first time, an electrode plate was heated at a heating temperature of 50 °C.

### Example 5

A preparation method in Example 5 was basically the same as that in Example 1, with the differences lying in the sintering process of the positive electrode active material and the hot-pressing process of the positive electrode plate.

Specifically:

(6) The precursor powder was subjected to two-stage heating sintering in a nitrogen atmosphere to obtain a positive electrode active material: a temperature was raised from 25 °C to 440 °C at a heating rate of 2 °C/min (a first heating stage) and then held for 2.5 hours; and a temperature was raised from 440 °C to 760 °C at a heating rate of 5 °C/min (a second heating stage) and held for 11 hours. A lithium iron phosphate positive electrode active material with a carbon material on its surface and a particle size Dv₅₀ of 1.6 μm was obtained through jet milling. A classification frequency of the jet milling was 25 Hz, and a crushing air pressure was 0.55 MPa.

(7) The positive electrode slurry was transfer-coated onto an aluminum foil, dried, and hot-pressed to obtain a positive electrode plate with a single-side surface density of a positive electrode film layer of 0.39 g/1540.25 mm² and a compacted density of 2.35 g/cm³. The compacted density here referred to the compacted density of the battery cell when it was fully discharged. A transfer-coating speed was 20 m/min.

A hot pressing process included three hot roller pressing processes. The hot roller pressing pressure increased successively, and the hot roller pressure was 45 tons, 60 tons, and 80 tons respectively; and a hot roller temperature was 60 °C. Before entering hot roller compaction for the first time, an electrode plate was heated at a heating temperature of 40 °C.

### Example 6

A preparation method in Example 6 was similar to that in Example 2, with the difference that during the preparation of the positive electrode plate, the aforementioned positive electrode active material, conductive agent, and binder polyvinylidene fluoride were uniformly mixed in a mass ratio of 94.52:1.99:2.99 in the solvent N-methylpyrrolidone. Then, based on the total mass of the positive electrode active material, conductive agent, binder polyvinylidene fluoride, and dispersant, a dispersant HNBR accounting for 0.5% by mass was added. The mixture was fully mixed, stirred, and dispersed in a stirring tank to prepare a positive electrode slurry, as detailed in Table 1.

### Example 7

A preparation method in Example 7 was similar to that in Example 6, with the difference that during the preparation of the positive electrode plate, the aforementioned positive electrode active material, conductive agent, and binder polyvinylidene fluoride were uniformly mixed in a mass ratio of 93.57:1.97:2.96 in the solvent N-methylpyrrolidone. Then, based on the total mass of the positive electrode active material, conductive agent, binder polyvinylidene fluoride, and dispersant, a dispersant HNBR accounting for 1.5% by mass was added, as detailed in Table 1.

### Example 8

A preparation method in Example 8 was similar to that in Example 1, with the difference that during the preparation of the positive electrode plate, the coating weight was adjusted, and parameters such as hot rolling pressure, hot roller temperature, transfer coating speed, and heating temperature before the first entry into the hot roller for compaction were adaptively adjusted. This ensured that the single-side surface density of the cold-pressed positive electrode film layer was 0.43 g/1540.25 mm², and the thickness of the battery was appropriately adjusted while keeping the number of positive electrode plates, separators, and negative electrode plates unchanged.

### Example 9

A preparation method in Example 9 was similar to that in Example 1, with the difference that during the preparation of the positive electrode plate, the coating weight was adjusted, and parameters such as hot rolling pressure, hot roller temperature, transfer coating speed, and heating temperature before the first entry into the hot roller for compaction were adaptively adjusted. This ensured that the single-side surface density of the cold-pressed positive electrode film layer was 0.26 g/1540.25 mm², and the thickness of the battery was appropriately adjusted while keeping the number of positive electrode plates, separators, and negative electrode plates unchanged.

### Example 10

A preparation method in Example 10 was similar to that in Example 1, with the difference that the aforementioned positive electrode active material, conductive agent, and binder polyvinylidene fluoride were mixed with a mass ratio of 95.48:1.5:3.02 in a solvent N-methylpyrrolidone. They were fully mixed and stirred in a stirring tank, and after dispersion, a positive electrode slurry was prepared. After the stirring process was completed, the positive electrode slurry was transported to a coating process. The conductive agent included conductive carbon black and multi-walled carbon nanotubes with a mass ratio of 0.5:1.

### Example 11

A preparation method in Example 11 was similar to that in Example 1, with the difference that parameters such as hot rolling pressure, hot roller temperature, transfer coating speed, and heating temperature before the first entry into the hot roller for compaction were adjusted. This resulted in a positive electrode plate with a single-side surface density of 0.38 g/1540.25 mm² and a compacted density of 2.55 g/cm³. The compacted density here referred to the compacted density of the battery cell when it was fully discharged. The thickness of the battery was appropriately adjusted while keeping the number of positive electrode plates, separators, and negative electrode plates unchanged.

### Comparative Example 1

A preparation method in Comparative Example 1 was basically the same as that in Example 1, with the differences lying in the sintering process of the positive electrode active material. Specifically:

The precursor powder was subjected to two-stage heating sintering in a nitrogen atmosphere to obtain a positive electrode active material: a temperature was raised from 25 °C to 500 °C at a heating rate of 2 °C/min (a first heating stage) and then held for 3.5 hours; and a temperature was raised from 500 °C to 800 °C at a heating rate of 5 °C/min (a second heating stage) and held for 13 hours. A lithium iron phosphate positive electrode active material with a carbon material on its surface and a particle size Dv50 of 1.6 μm was obtained through jet milling. A classification frequency of the jet milling was 25 Hz, and a crushing air pressure was 0.55 MPa.

### Comparative Example 2

A preparation method in Comparative Example 2 was similar to that in Comparative Example 1, with the difference that during the preparation of the positive electrode plate, the aforementioned positive electrode active material, conductive agent, and binder polyvinylidene fluoride were uniformly mixed in a mass ratio of 93.57:1.97:2.96 in the solvent N-methylpyrrolidone. Then, based on the total mass of the positive electrode active material, conductive agent, binder polyvinylidene fluoride, and dispersant, a dispersant HNBR accounting for 1.5% by mass was added.

### Comparative Example 3

A preparation method in Comparative Example 3 was similar to that in Example 1, with the difference that during the preparation of the positive electrode plate, the coating weight was adjusted. This ensured that the single-side surface density of the cold-pressed positive electrode film layer was 0.24 g/1540.25 mm², and the thickness of the battery was appropriately adjusted while keeping the number of positive electrode plates, separators, and negative electrode plates unchanged.

### Test Method

### 1. Capacity of Battery Cell

At 25 °C, a battery cell was charged at a charge rate of 0.5 C (based on its nominal capacity) to 3.65V, then subjected to constant-voltage charging at 3.65V to 0.05 C. After standing for 10 minutes, it was discharged at a discharge rate of 1 C to 2.5V and then allowed to stand for 10 minutes. The capacity C during the discharge process was calculated using the formula C=I*t, with the unit being Ah.

### 2. Cycle Number Corresponding to Capacity Decay to 80%

At 25 °C, the battery cell was charged at a charge rate of 0.5 C (based on its nominal capacity) to 3.65V, then subjected to constant-voltage charging at 3.65V to 0.05 C. After standing for 10 minutes, it was discharged at a discharge rate of 1 C to 2.5V and then allowed to stand for 10 minutes. One charge-discharge cycle was defined as one cycle, and the test was stopped when the battery capacity decays to 80% of the nominal capacity, recorded as a cycle number @80% SOH.

### Test Results

The test results of the above examples and comparative examples are shown in Table 1 and Table 2.

TABLE 1

| | Positive electrode film layer | | | | | | | |
|---|---|---|---|---|---|---|---|---|
| | | | Area | | | | | |
| | | | proportion | Distribution | | | | |
| | | | of | uniformity | | | | |
| | | | particles | of particles | | | | |
| | | | having a | having a | | | | |
| | Single-side | | particle | particle | | | | |
| | surface | | size R1 | size R1 | | | Battery | |
| | density | Compacted | satisfying | satisfying | | Content | @80% | |
| | g/1540.25 | density | R1 ≥ | R1 ≥ | Type of | of | SOH | Capacity |
| | mm² | (g/cm³) | 1000 nm | 1000 nm | dispersant | dispersant | (cycles) | (Ah) |
| Example 1 | 0.38 | 2.35 | 36.83% | 1.9% | / | / | 2018 | 162 |
| Example 2 | 0.38 | 2.35 | 34.89% | 0.99% | / | / | 2087 | 163 |
| Example 3 | 0.39 | 2.36 | 34.97% | 1.47% | / | / | 2084 | 164 |
| Example 4 | 0.39 | 2.36 | 49.99% | 4.91% | / | / | 1990 | 163 |
| Example 5 | 0.38 | 2.35 | 12.11% | 1.82% | / | / | 2049 | 161 |
| Example 6 | 0.38 | 2.35 | 34.93% | 0.45% | HNBR | 0.5% | 2120 | 162 |
| Example 7 | 0.38 | 2.35 | 34.88% | 0.24% | HNBR | 1.5% | 2135 | 161 |
| Example 8 | 0.43 | 2.35 | 36.92% | 1.98% | / | / | 2012 | 182 |
| Example 9 | 0.26 | 2.35 | 36.75% | 1.81% | / | / | 2025 | 107 |
| Example 10 | 0.38 | 2.35 | 36.73% | 1.85% | / | / | 2003 | 162 |
| Example 11 | 0.38 | 2.55 | 36.87% | 1.94% | / | / | 2009 | 161 |
| Comparative | 0.39 | 2.36 | 56.75% | 5.58% | / | / | 1899 | 162 |
| Example 1 | | | | | | | | |
| Comparative | 0.39 | 2.36 | 56.81% | 4.50% | HNBR | 1.5% | 1908 | 162 |
| Example 2 | | | | | | | | |
| Comparative | 0.24 | 2.35 | 36.81% | 1.87% | / | / | 2016 | 101 |
| Example 3 | | | | | | | | |

From the comparison between the examples and the comparative examples, it can be seen that the battery cell includes a stacked electrode assembly, the stacked electrode assembly includes a positive electrode plate and a negative electrode plate, the positive electrode plate includes a positive electrode current collector and a positive electrode film layer disposed on at least one side of the positive electrode current collector, and the positive electrode film layer includes lithium-containing transition metal phosphate particles with a carbon material disposed on at least a portion of surfaces. When the battery cell is fully discharged, the positive electrode plate has a compacted density of 2.3 g/cm³ to 2.6 g/cm³; a single-side surface density of the positive electrode film layer is 0.25 g/1540.25 mm² to 0.45 g/1540.25 mm²; based on a total area of particles in a cross-section of the positive electrode film layer along a thickness direction of the electrode plate, an area proportion of particles having a particle size R1 satisfying R1≥1000 nm is 12% to 50%; and in the cross-section of the positive electrode film layer along the thickness direction of the electrode plate, a distribution uniformity of the particles having the particle size R1 satisfying R1≥1000 nm is less than or equal to 5%. The battery cell helps improve cycle stability during a long cycle process while maintaining the good capacity.

From the comparison between Examples 1-3 and Examples 4-5, it can be seen that, based on the total area of the particles in the cross-section of the positive electrode film layer along the thickness direction of the electrode plate, the area proportion of the particles having the particle size R1 satisfying R1≥1000 nm is further in the range of 12% to 37%, which helps to further improve the capacity and long-cycle stability of the battery.

From the comparison between Example 4 and Examples 1-3, and 5-11, and between Example 2 and Examples 6-7, it can be seen that, in the cross-section of the positive electrode film layer along the thickness direction of the electrode plate, the distribution uniformity of the particles having the particle size R1 satisfying R1≥1000 nm is in the range of 0.2% to 2%, and further in the range of 0.2% to 0.9%, which helps to further improve the long-cycle stability of the battery.

From the comparison between Example 1 and Examples 8-9, it can be seen that, the single-side coating surface density of the positive electrode film layer is further within the range of 0.3 g/1540.25 mm² to 0.45 g/1540.25 mm², and further within the range of 0.35 g/1540.25 mm² to 0.4 g/1540.25 mm², which helps to further balance the battery capacity and long-cycle stability.

TABLE 2

| | | | Area proportion of | |
|---|---|---|---|---|
| | | | agglomeration region | @80% SOH |
| | C1 | C2 | of conductive agent | (cycles) |
| Example 1 | 1% | 1% | 1.68% | 2018 |
| Example 10 | 1% | 0.5% | 2.41% | 2003 |

From the comparison between Example 1 and Example 10, it can be seen that, based on the total area of the cross-section of the positive electrode film layer along the thickness direction of the electrode plate, the area proportion of the agglomeration region of the conductive agent is in the range of 0.5% to 2.5%, and further in the range of 1.5% to 2.5%, which helps to further improve the long-cycle stability of the battery.

It should be noted that the present application is not limited to the embodiments above. The above embodiments are only examples, and embodiments that have the same composition and exert the same effect as the technical ideas within the scope of the technical solution of the present application are included in the technical scope of the present application. In addition, without departing from the scope of the main intention of the present application, various modifications that can be conceived by those skilled in the art for the embodiments, and other forms constructed by combining some of the constituent elements of the embodiments are also included within the scope of the present application.

1. A battery cell, comprising a stacked electrode assembly, wherein the stacked electrode assembly comprises a positive electrode plate and a negative electrode plate, the positive electrode plate comprises a positive electrode current collector and a positive electrode film layer disposed on at least one side of the positive electrode current collector, and the positive electrode film layer comprises lithium-containing transition metal phosphate particles with a carbon material disposed on at least a portion of a surface of the lithium-containing transition metal phosphate particles;
when the battery cell is fully discharged, the positive electrode plate has a compacted density of 2.3 g/cm³ to 2.6 g/cm³;
a single-side surface density of the positive electrode film layer is 0.25 g/1540.25 mm² to 0.45 g/1540.25 mm²;
based on a total area of particles in a cross-section of the positive electrode film layer along a thickness direction of the electrode plate, an area proportion of particles having a particle size R1 satisfying R1≥1000 nm is 12% to 50%;
in the cross-section of the positive electrode film layer along the thickness direction of the electrode plate, a distribution uniformity of the particles having the particle size R1 satisfying R1≥1000 nm is less than or equal to 5%; and
in the cross-section of the positive electrode film layer along the thickness direction of the electrode plate, in a cumulative distribution curve of sphericity area of the particles having the particle size R1 satisfying R1≥1000 nm, a median sphericity L_{R1A50} is 0.6 to 0.8.

2. The battery cell according to claim 1, wherein a single-side thickness H of the positive electrode film layer is 70 μm to 120 μm.

3. The battery cell according to claim 1, wherein,
in a cumulative distribution curve of degree of graphitization C value of the positive electrode film layer obtained by a laser microscopic confocal Raman spectrometer in a surface scanning mode, a median C₅₀ of the degree of graphitization is greater than or equal to 0.95 and less than or equal to 1.2; wherein the degree of graphitization C value is I_{G}/I_{D}, I_{G} represents a G-band intensity of a Raman spectrum at 1580±100 cm⁻¹, and I_{D} represents a D-band intensity of the Raman spectrum at 1350±100 cm⁻¹.

4. The battery cell according to claim 1, wherein, in a cumulative distribution curve of coating value B of the positive electrode film layer obtained by a laser microscopic confocal Raman spectrometer in a surface scanning mode, a median B₅₀ of the coating value is 0.30 to 0.60, wherein the coating value B is I_{P}/I_{D}, I_{P} represents a P-band intensity of a Raman spectrum at 948±100 cm⁻¹, and I_{D} represents a D-band intensity of the Raman spectrum at 1350±100 cm⁻¹.

5. The battery cell according to claim 1, wherein the lithium-containing transition metal phosphate particles in the positive electrode film layer comprise components represented by the following general formula:
LiₘFeₓP_{y}OⱼQ_{q} Formula I,
where Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

6. The battery cell according to claim 5, wherein an iron dissolution rate of a positive electrode material is 658 ppm to 1921 ppm.

7. The battery cell according to claim 5, wherein based on total mass of the lithium-containing transition metal phosphate particles in the positive electrode film layer, a mass content of a titanium element is 500 ppm to 8000 ppm.

8. The battery cell according to claim 5, wherein based on a total mass of the lithium-containing transition metal phosphate particles in the positive electrode film layer, a mass content of a vanadium element is 500 ppm to 5000 ppm.

9. The battery cell according to claim 1, wherein the positive electrode film layer further comprises a conductive agent, and based on a total area of a cross-section of the positive electrode film layer along the thickness direction of the electrode plate, an area proportion of an agglomeration region of the conductive agent is 0.5% to 2.5%.

10. The battery cell according to claim 9, wherein the conductive agent comprises carbon nanotubes, the carbon nanotubes comprise one or more of single-walled carbon nanotubes, few-walled carbon nanotubes, and multi-walled carbon nanotubes.

11. The battery cell according to claim 9, wherein the agglomeration region of the conductive agent comprises carbon nanotubes and conductive carbon black, wherein based on mass of the positive electrode film layer, a mass content C1 of the carbon nanotubes satisfies: 0<C1≤2.5%, and a mass content C2 of the conductive carbon black satisfies: 0<C2≤2.5%.

12. The battery cell according to claim 1, wherein the positive electrode film layer further comprises a dispersant, and the dispersant comprises hydrogenated nitrile rubber (HNBR), wherein based on a mass of the positive electrode film layer, a mass content of the dispersant is 0.5% to 2%.

13. The battery cell according to claim 1, wherein a porosity of the positive electrode film layer is 14% to 28%.

14. The battery cell according to claim 1, wherein the battery cell also comprises a separator arranged between the positive electrode plate and the negative electrode plate, the separator comprises a base membrane, ceramic layers arranged on two sides of the base membrane, and an adhesive layer arranged on one side of the ceramic layer located on at least one side away from the base membrane, the adhesive layer is a continuous layer with a porous structure, and the adhesive layer comprise a vinylidene fluoride polymer, wherein the separator meets the following conditions:
(1) a thickness of the base membrane is 7-9 μm;
(2) a single-side thickness of the ceramic layer is 2-4 μm;
(3) a single-side thickness of the adhesive layer is 1-5 μm.

15. The battery cell according to claim 1, wherein the positive electrode film layer is provided with a primer layer in a bottom region near the positive electrode current collector, and the primer layer meets the following conditions:
(1) the primer layer comprises a conductive agent and a binder, the conductive agent comprises carbon nanotubes and conductive carbon black, and the binder comprises a vinylidene fluoride polymer;
(2) a thickness of the primer layer is 0.5 μm to 5 μm.

16. The battery cell according to claim 1, wherein the battery cell comprises a shell, the stacked electrode assembly is accommodated in the shell, a dimension of the shell in a length direction is L₁, a dimension of the shell in a width direction is W₁, and a dimension of the shell in a thickness direction is H₁, wherein 450 mm≤L₁ 1300 mm, 100 mm≤W₁≤150 mm, and 14 mm≤H₁≤22 mm, wherein
a material of the shell is a soft-pack material, and the soft-pack material comprises an aluminum-plastic composite film.

17. The battery cell according to claim 1, wherein at 25 °C, a capacity of the battery cell is 105 Ah to 300 Ah.

18. A battery apparatus, comprising the battery cell according to claim 1.

19. An electrical apparatus, comprising the battery apparatus according to claim 18, wherein the battery apparatus is configured to provide electric energy.

20. The battery cell according to claim 1, wherein the median sphericity L_{R1A50} is in a range of 0.67 to 0.75.
